(19) United States
(12) Patent Application Publication
(10) Pub. No.: US 2019/0108311 A1
(43) Pub. Date: Apr. 11, 2019

(54) SITE-SPECIFIC NOISE MODEL FOR TARGETED SEQUENCING

(71) Applicant: GRAIL, Inc., Menlo Park, CA (US)

(72) Inventors: Alexander W. Blocker, Mountain View, CA (US); Earl Hubbell, Palo Alto, CA (US)

(21) Appl. No.: 16/153,593

(22) Filed: Oct. 5, 2018

Related U.S. Application Data
(60) Provisional application No. 62/569,367, filed on Oct. 6, 2017.

(51) Int. Cl. G06F 19/22; G06F 19/24; G06F 19/28; G06N 5/04

(52) U.S. Cl. CPC G06F 19/22; G06N 5/04; G06F 19/28; G06F 19/24

(57) ABSTRACT

A processing system uses a Bayesian inference based model for targeted sequencing or variant calling. In an embodiment, the processing system determines first depths and first alternate depths of first sequence reads from a cell free nucleic acid sample of a subject. The processing system determines second depths and second alternate depths of second sequence reads from a genomic nucleic acid sample of the subject. The processing system determines likelihoods of true alternate frequency of the cell free nucleic acid sample and of the genomic nucleic acid sample. Using the first likelihood, the second likelihood, and one or more parameters, the processing system determines a probability that the true alternate frequency of the cell free nucleic acid sample is greater than a function of the true alternate frequency of the genomic nucleic acid sample.

### CROSS REFERENCE TO RELATED APPLICATIONS

This application claims the benefit of priority to U.S. Provisional Application No. 62/569,367, filed on Oct. 6, 2017, which is incorporated herein by reference in its entirety for all purposes.

### BACKGROUND

### 1. Field of Art

This disclosure generally relates to a Bayesian inference based model for targeted sequencing and to leveraging the model in variant calling and quality control.

### 2. Description of the Related Art

Computational techniques can be used on DNA sequencing data to identify mutations or variants in DNA that may correspond to various types of cancer or other diseases. Thus, cancer diagnosis or prediction may be performed by analyzing a biological sample such as a tissue biopsy or blood drawn from a subject. Detecting DNA that originated from tumor cells from a blood sample is difficult because circulating tumor DNA (ctDNA) is typically present at low levels relative to other molecules in cell-free DNA (cfDNA) extracted from the blood. The inability of existing methods to identify true positives (e.g., indicative of cancer in the subject) from signal noise diminishes the ability of known and future systems to distinguish true positives from false positives caused by noise sources, which can result in unreliable results for variant calling or other types of analyses.

### SUMMARY

Disclosed herein are methods for training and applying a site-specific noise model (also referred to herein as a “Bayesian hierarchical model,” “noise model,” or “model”) for determining likelihoods of true positives in targeted sequencing. True positives may include single nucleotide variants, insertions, or deletions of base pairs. In particular, the model may use Bayesian inference to determine a rate or level of noise, e.g., indicative of an expected likelihood of certain mutations, per position of a nucleic acid sequence. Moreover, the model may be a hierarchical model that accounts for covariates (e.g., trinucleotide context, mappability, or segmental duplication) and various types of parameters (e.g., mixture components or depth of sequence reads). The model may be trained by Markov chain Monte Carlo sampling from sequence reads of healthy subjects. Therefore, an overall pipeline that incorporates the model can identify true positives at higher sensitivities and filter out false positives.

In various embodiments, a method for processing sequencing data of a nucleic acid sample includes identifying a candidate variant of a plurality of sequence reads. The method further includes accessing a plurality of parameters including a dispersion parameter r and a mean rate parameter m specific to the candidate variant, where the r and m are derived using a model. The method further includes inputting read information of the plurality of sequence reads into a function parameterized by the plurality of parameters. The method further includes determining a score for the candidate variant using an output of the function based on the input read information.

In one or more embodiments, the plurality of parameters represent mean and shape parameters of a gamma distribution, and the function is a negative binomial based on the plurality of sequence reads and the plurality of parameters.

In one or more embodiments, the plurality of parameters represent parameters of a distribution that encodes an uncertainty level of nucleotide mutations with respect to a given position of a sequence read.

In one or more embodiments, a gamma distribution is one component of a mixture of the distribution.

In one or more embodiments, the plurality of parameters are derived from a training sample of sequence reads from a plurality of healthy individuals.

In one or more embodiments, the training sample excludes a subset of the sequence reads from the plurality of healthy individuals based on filtering criteria.

In one or more embodiments, the filtering criteria indicates to exclude sequence reads that have (i) a depth less than a threshold value or (ii) an allele frequency greater than a threshold frequency.

In one or more embodiments, the filtering criteria varies based on positions of candidate variants in a genome.

In one or more embodiments, the plurality of parameters are derived using a Bayesian Hierarchical model.

In one or more embodiments, the Bayesian Hierarchical model includes a multinomial distribution grouping positions of sequence reads into latent classes.

In one or more embodiments, the Bayesian Hierarchical model includes fixed covariates unrelated to training samples from healthy individuals.

In one or more embodiments, the covariates are based on a plurality of nucleotides adjacent to a given position of a sequence read.

In one or more embodiments, the covariates are based on a level of uniqueness of a given sequence read relative to a target region of a genome.

In one or more embodiments, the covariates are based whether a given sequence read is a segmental duplication.

In one or more embodiments, the Bayesian Hierarchical model is estimated using a Markov chain Monte Carlo method.

In one or more embodiments, the Markov chain Monte Carlo method uses a Metropolis-Hastings algorithm.

In one or more embodiments, the Markov chain Monte Carlo method uses a Gibbs sampling algorithm.

In one or more embodiments, the Markov chain Monte Carlo method uses Hamiltonian mechanics.

In one or more embodiments, the read information includes a depth d of the plurality of sequence reads, the function parameterized by m·d.

In one or more embodiments, the score is a Phred-scaled likelihood.

In one or more embodiments, the plurality of sequence reads are obtained from a cell free nucleotide sample obtained from an individual.

In one or more embodiments, the method further includes collecting or having collected the cell free nucleotide sample from a blood sample of the individual, and performing enrichment on the cell free nucleotide sample to generate the plurality of sequence reads.

In one or more embodiments, the plurality of sequence reads are obtained from a sample of blood, whole blood, plasma, serum, urine, cerebrospinal fluid, fecal, saliva, tears, a tissue biopsy, pleural fluid, pericardial fluid, or peritoneal fluid of an individual.

In one or more embodiments, the plurality of sequence reads are obtained from tumor cells obtained from a tumor biopsy.

In one or more embodiments, the plurality of sequence reads is sequenced from an isolate of cells from blood, the isolate of cells including at least buffy coat white blood cells or CD4+ cells.

In one or more embodiments, the method further includes determining that the candidate variant is a false positive mutation responsive to comparing the score to a threshold value.

In one or more embodiments, the candidate variant is a single nucleotide variant.

In one or more embodiments, the model encodes noise levels of nucleotide mutations for one base of A, T, C, and G to each of the other three bases.

In one or more embodiments, the candidate variant is an insertion or deletion of at least one nucleotide.

In one or more embodiments, the model includes a distribution of lengths of insertions or deletions.

In one or more embodiments, model separates inference for determining a likelihood of an alternate allele from inference for determining a length of the alternate allele using the distribution of lengths.

In one or more embodiments, the distribution of lengths is multinomial with Dirichlet prior.

In one or more embodiments, the Dirichlet prior on the multinomial distribution of lengths is determined by covariates of anchor positions of a genome.

In one or more embodiments, the model includes a distribution ω determined based on covariates.

In one or more embodiments, the model includes a distribution ϕ determined based on covariates and anchor positions of a genome.

In one or more embodiments, the model includes a multinomial distribution grouping lengths of insertions or deletions at anchor positions of sequence reads into latent classes.

In one or more embodiments, an expected mean total count of insertions or deletions at a given anchor position is modeled by a distribution based on covariates and anchor positions of a genome.

### BRIEF DESCRIPTION OF DRAWINGS

Figure (FIG. 1 is flowchart of a method for preparing a nucleic acid sample for sequencing according to one embodiment.

FIG. 2 is block diagram of a processing system for processing sequence reads according to one embodiment.

FIG. 3 is flowchart of a method for determining variants of sequence reads according to one embodiment.

FIG. 4 is a diagram of an application of a Bayesian hierarchical model according to one embodiment.

FIG. 5A shows dependencies between parameters and sub-models of a Bayesian hierarchical model for determining true single nucleotide variants according to one embodiment.

FIG. 5B shows dependencies between parameters and sub-models of a Bayesian hierarchical model for determining true insertions or deletions according to one embodiment.

FIGS. 6A-B illustrate diagrams associated with a Bayesian hierarchical model according to one embodiment.

FIG. 7A is a diagram of determining parameters by fitting a Bayesian hierarchical model according to one embodiment.

FIG. 7B is a diagram of using parameters from a Bayesian hierarchical model to determine a likelihood of a false positive according to one embodiment.

FIG. 8 is flowchart of a method for training a Bayesian hierarchical model according to one embodiment.

FIG. 9 is flowchart of a method for determining a likelihood of a false positive according to one embodiment.

FIG. 10 is a diagram of mutation-specific noise rates according to one embodiment.

FIG. 11 is a diagram of noise rates based on reference allele and trinucleotide context according to one embodiment.

FIG. 12 is a diagram of distributions of quality score deviations by reference allele according to one embodiment.

FIGS. 13A-B show diagrams illustrating deviations from median quality scores by reference allele according to one embodiment.

FIG. 14 is a diagram of quality scores by reference allele at a low alternate depth according to one embodiment.

FIG. 15 is a diagram of mean calls per sample using a model across sample targeted sequencing studies according to one embodiment.

FIG. 16 is a diagram of positive percentage agreement (PPA) results for sequence data from cfDNA samples and from matched tumor biopsy samples according to one embodiment.

FIG. 17 is another diagram of positive percentage agreement results for sequence data using a model according to one embodiment.

FIG. 18 is a diagram depicting the number of mutations detected in specific genes from targeted sequencing data from subjects with lung cancer according to one embodiment.

FIG. 19 is a diagram depicting the number of mutations detected in specific genes from targeted sequencing data from subjects with prostate cancer according to one embodiment.

FIG. 20 is a diagram depicting the number of mutations detected in specific genes from targeted sequencing data from subjects with breast cancer according to one embodiment.

FIG. 21 is a diagram of filtered recurrent mutations from healthy samples using a model according to one embodiment.

FIG. 22 is a diagram of filtered recurrent mutations from cancer samples using a model according to one embodiment.

FIG. 23 is a diagram of noise rates for indels determined using a model according to one embodiment.

FIG. 24 is another diagram of noise rates for indels determined using a model according to one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. Definitions

The term “individual” refers to a human individual. The term “healthy individual” refers to an individual presumed to not have a cancer or disease. The term “subject” refers to an individual who is known to have, or potentially has, a cancer or disease.

The term “sequence reads” refers to nucleotide sequences read from a sample obtained from an individual. Sequence reads can be obtained through various methods known in the art.

The term “read segment” or “read” refers to any nucleotide sequences including sequence reads obtained from an individual and/or nucleotide sequences derived from the initial sequence read from a sample obtained from an individual. For example, a read segment can refer to an aligned sequence read, a collapsed sequence read, or a stitched read. Furthermore, a read segment can refer to an individual nucleotide base, such as a single nucleotide variant.

The term “single nucleotide variant” or “SNV” refers to a substitution of one nucleotide to a different nucleotide at a position (e.g., site) of a nucleotide sequence, e.g., a sequence read from an individual. A substitution from a first nucleobase X to a second nucleobase Y may be denoted as “X>Y.” For example, a cytosine to thymine SNV may be denoted as “C>T.”

The term “indel” refers to any insertion or deletion of one or more base pairs having a length and a position (which may also be referred to as an anchor position) in a sequence read. An insertion corresponds to a positive length, while a deletion corresponds to a negative length.

The term “mutation” refers to one or more SNVs or indels.

The term “candidate variant,” “called variant,” or “putative variant,” refers to one or more detected nucleotide variants of a nucleotide sequence, for example, at a position in the genome that is determined to be mutated (i.e., a candidate SNV) or an insertion or deletion at one or more bases (i.e., a candidate indel). Generally, a nucleotide base is deemed a called variant based on the presence of an alternative allele on a sequence read, or collapsed read, where the nucleotide base at the position(s) differ from the nucleotide base in a reference genome. Additionally, candidate variants may be called as true positives or false positives.

The term “true positive” refers to a mutation that indicates real biology, for example, presence of a potential cancer, disease, or germline mutation in an individual. True positives are not artifacts that may mimic real biology. For example, recurrent apparent variants in healthy individuals are likely to be technical artifacts rather than biology, and various process errors can lead to spurious variants.

The term “false positive” refers to a mutation incorrectly determined to be a true positive. Generally, false positives may be more likely to occur when processing sequence reads associated with greater mean noise rates or greater uncertainty in noise rates.

The term “cell-free nucleic acids” or “cfNAs” refers to nucleic acid molecules that can be found outside cells, in bodily fluids such blood, sweat, urine, or saliva. Cell-free nucleic acids are used interchangeably as circulating nucleic acids.

The term “cell-free DNA” or “cfDNA” refers to nucleic acid fragments that circulate in bodily fluids such blood, sweat, urine, or saliva and originate from one or more healthy cells and/or from one or more cancer cells.

The term “circulating tumor DNA” or “ctDNA” refers to deoxyribonucleic acid fragments that originate from tumor cells or other types of cancer cells, which may be released into an individual's bodily fluids such blood, sweat, urine, or saliva as result of biological processes such as apoptosis or necrosis of dying cells or actively released by viable tumor cells.

The term “circulating tumor RNA” or “ctRNA” refers to ribonucleic acid fragments that originate from tumor cells or other types of cancer cells, which may be released into an individual's bodily fluids such blood, sweat, urine, or saliva as result of biological processes such as apoptosis or necrosis of dying cells or actively released by viable tumor cells.

The term “alternative allele” or “ALT” refers to an allele having one or more mutations relative to a reference allele, e.g., corresponding to a known gene.

The term “sequencing depth” or “depth” refers to a total number of read segments from a sample obtained from an individual at a given position, region, or loci. In some embodiments, the depth refers to the average sequencing depth across the genome or across a targeted sequencing panel.

The term “alternate depth” or “AD” refers to a number of read segments in a sample that support an ALT, e.g., include mutations of the ALT.

The term “alternate frequency” or “AF” refers to the frequency of a given ALT. The AF may be determined by dividing the corresponding AD of a sample by the depth of the sample for the given ALT.

### II. Example Assay Protocol

FIG. 1 is flowchart of a method 100 for preparing a nucleic acid sample for sequencing according to one embodiment. The method 100 includes, but is not limited to, the following steps. For example, any step of the method 100 may comprise a quantitation sub-step for quality control or other laboratory assay procedures known to one skilled in the art.

In step 110, a test sample comprising a plurality of nucleic acid molecules (DNA or RNA) is obtained from a subject, and the nucleic acids are extracted and/or purified from the test sample. In the present disclosure, DNA and RNA may be used interchangeably unless otherwise indicated. That is, the following embodiments for using error source information in variant calling and quality control may be applicable to both DNA and RNA types of nucleic acid sequences. However, the examples described herein may focus on DNA for purposes of clarity and explanation. The nucleic acids in the extracted sample may comprise the whole human genome, or any subset of the human genome, including the whole exome. Alternatively, the sample may be any subset of the human transcriptome, including the whole transcriptome. The test sample may be obtained from a subject known to have or suspected of having cancer. In some embodiments, the test sample may include blood, plasma, serum, urine, fecal, saliva, other types of bodily fluids, or any combination thereof. Alternatively, the test sample may comprise a sample selected from the group consisting of whole blood, a blood fraction, a tissue biopsy, pleural fluid, pericardial fluid, cerebral spinal fluid, and peritoneal fluid. In some embodiments, methods for drawing a blood sample (e.g., syringe or finger prick) may be less invasive than procedures for obtaining a tissue biopsy, which may require surgery. The extracted sample may comprise cfDNA and/or ctDNA. For healthy individuals, the human body may naturally clear out cfDNA and other cellular debris. In general, any known method in the art can be used to extract and purify cell-free nucleic acids from the test sample. For example, cell-free nucleic acids can be extracted and purified using one or more known commercially available protocols or kits, such as the QIAamp circulating nucleic acid kit (Qiagen). If a subject has a cancer or disease, ctDNA in an extracted sample may be present at a detectable level for diagnosis.

In step 120, a sequencing library is prepared. During library preparation, sequencing adapters comprising unique molecular identifiers (UMI) are added to the nucleic acid molecules (e.g., DNA molecules), for example, through adapter ligation (using T4 or T7 DNA ligase) or other known means in the art. The UMIs are short nucleic acid sequences (e.g., 4-10 base pairs) that are added to ends of DNA fragments and serve as unique tags that can be used to identify nucleic acids (or sequence reads) originating from a specific DNA fragment. Following adapter addition, the adapter-nucleic acid constructs are amplified, for example, using polymerase chain reaction (PCR). During PCR amplification, the UMIs are replicated along with the attached DNA fragment, which provides a way to identify sequence reads that came from the same original fragment in downstream analysis. Optionally, as is well known in the art, the sequencing adapters may further comprise a universal primer, a sample-specific barcode (for multiplexing) and/or one or more sequencing oligonucleotides for use in subsequent cluster generation and/or sequencing (e.g., known P5 and P7 sequences for used in sequencing by synthesis (SBS) (Illumina, San Diego, Calif.)).

In step 130, targeted DNA sequences are enriched from the library. In accordance with one embodiment, during targeted enrichment, hybridization probes (also referred to herein as “probes”) are used to target, and pull down, nucleic acid fragments known to be, or that may be, informative for the presence or absence of cancer (or disease), cancer status, or a cancer classification (e.g., cancer type or tissue of origin). For a given workflow, the probes may be designed to anneal (or hybridize) to a target (complementary) strand of DNA or RNA. The target strand may be the “positive” strand (e.g., the strand transcribed into mRNA, and subsequently translated into a protein) or the complementary “negative” strand. The probes may range in length from 10 s, 100 s, or 1000 s of base pairs. In one embodiment, the probes are designed based on a gene panel to analyze particular mutations or target regions of the genome (e.g., of the human or another organism) that are suspected to correspond to certain cancers or other types of diseases. Moreover, the probes may cover overlapping portions of a target region. As one of skill in the art would readily appreciate, any known means in the art can be used for targeted enrichment. For example, in one embodiment, the probes may be biotinylated and streptavidin coated magnetic beads used to enrich for probe captured target nucleic acids. See, e.g., Duncavage et al., J Mol Diagn. 13(3): 325-333 (2011); and Newman et al., Nat Med. 20(5): 548-554 (2014). By using a targeted gene panel rather than sequencing the whole genome (“whole genome sequencing”), all expressed genes of a genome (“whole exome sequencing” or “whole transcriptome sequencing”), the method 100 may be used to increase sequencing depth of the target regions, where depth refers to the count of the number of times a given target sequence within the sample has been sequenced. Increasing sequencing depth allows for detection of rare sequence variants in a sample and/or increases the throughput of the sequencing process. After a hybridization step, the hybridized nucleic acid fragments are captured and may also be amplified using PCR.

In step 140, sequence reads are generated from the enriched nucleic acid molecules (e.g., DNA molecules). Sequencing data or sequence reads may be acquired from the enriched nucleic acid molecules by known means in the art. For example, the method 100 may include next generation sequencing (NGS) techniques including synthesis technology (Illumina), pyrosequencing (454 Life Sciences), ion semiconductor technology (Ion Torrent sequencing), single-molecule real-time sequencing (Pacific Biosciences), sequencing by ligation (SOLiD sequencing), nanopore sequencing (Oxford Nanopore Technologies), or paired-end sequencing. In some embodiments, massively parallel sequencing is performed using sequencing-by-synthesis with reversible dye terminators.

In various embodiments, the enriched nucleic acid sample 115 is provided to the sequencer 145 for sequencing. As shown in FIG. 1, the sequencer 145 can include a graphical user interface 150 that enables user interactions with particular tasks (e.g., initiate sequencing or terminate sequencing) as well as one more loading trays 155 for providing the enriched fragment samples and/or necessary buffers for performing the sequencing assays. Therefore, once a user has provided the necessary reagents and enriched fragment samples to the loading trays 155 of the sequencer 145, the user can initiate sequencing by interacting with the graphical user interface 150 of the sequencer 145. In step 140, the sequencer 145 performs the sequencing and outputs the sequence reads of the enriched fragments from the nucleic acid sample 115.

In some embodiments, the sequencer 145 is communicatively coupled with one or more computing devices 160. Each computing device 160 can process the sequence reads for various applications such as variant calling or quality control. The sequencer 145 may provide the sequence reads in a BAM file format to a computing device 160. Each computing device 160 can be one of a personal computer (PC), a desktop computer, a laptop computer, a notebook, a tablet PC, or a mobile device. A computing device 160 can be communicatively coupled to the sequencer 145 through a wireless, wired, or a combination of wireless and wired communication technologies. Generally, the computing device 160 is configured with a processor and memory storing computer instructions that, when executed by the processor, cause the processor to process the sequence reads or to perform one or more steps of any of the methods or processes disclosed herein.

In some embodiments, the sequence reads may be aligned to a reference genome using known methods in the art to determine alignment position information. For example, in one embodiment, sequence reads are aligned to human reference genome hg19. The sequence of the human reference genome, hg19, is available from Genome Reference Consortium with a reference number, GRCh37/hg19, and also available from Genome Browser provided by Santa Cruz Genomics Institute. The alignment position information may indicate a beginning position and an end position of a region in the reference genome that corresponds to a beginning nucleotide base and end nucleotide base of a given sequence read. Alignment position information may also include sequence read length, which can be determined from the beginning position and end position. A region in the reference genome may be associated with a gene or a segment of a gene.

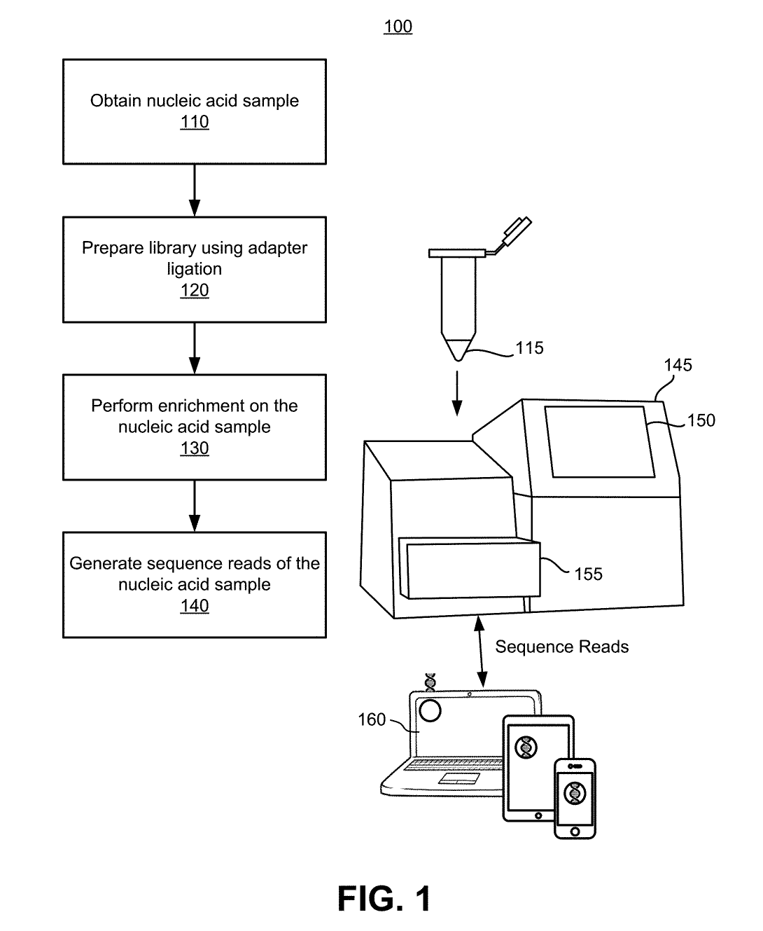

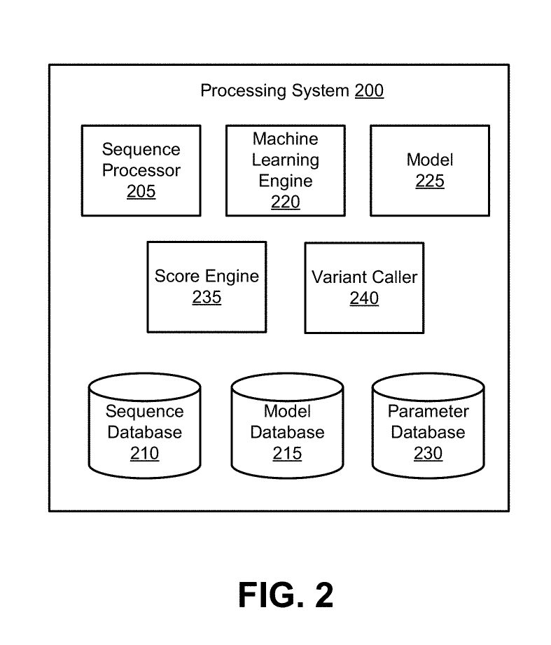

In various embodiments, for example when a paired-end sequencing process is used, a sequence read is comprised of a read pair denoted as R₁ and R₂. For example, the first read R₁ may be sequenced from a first end of a double-stranded DNA (dsDNA) molecule whereas the second read R₂ may be sequenced from the second end of the double-stranded DNA (dsDNA). Therefore, nucleotide base pairs of the first read R₁ and second read R₂ may be aligned consistently (e.g., in opposite orientations) with nucleotide bases of the reference genome. Alignment position information derived from the read pair R₁ and R₂ may include a beginning position in the reference genome that corresponds to an end of a first read (e.g., R₁) and an end position in the reference genome that corresponds to an end of a second read (e.g., R₂). In other words, the beginning position and end position in the reference genome represent the likely location within the reference genome to which the nucleic acid fragment corresponds. An output file having SAM (sequence alignment map) format or BAM (binary) format may be generated and output for further analysis such as variant calling, as described below with respect to FIG. 2.

### III. Example Processing System

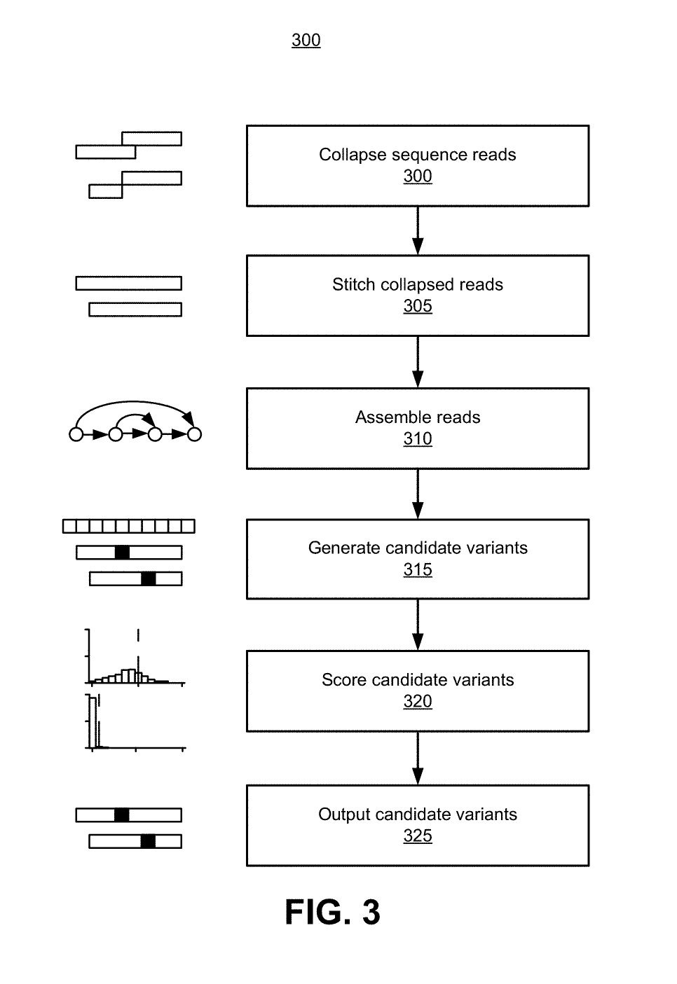

FIG. 2 is block diagram of a processing system 200 for processing sequence reads according to one embodiment. The processing system 200 includes a sequence processor 205, sequence database 210, model database 215, machine learning engine 220, model 225 (for example, a “Bayesian hierarchical model”), parameter database 230, score engine 235, and variant caller 240. FIG. 3 is flowchart of a method 300 for determining variants of sequence reads according to one embodiment. In some embodiments, the processing system 200 performs the method 300 to perform variant calling (e.g., for SNVs and/or indels) based on input sequencing data. Further, the processing system 300 may obtain the input sequencing data from an output file associated with nucleic acid sample prepared using the method 100 described above. The method 300 includes, but is not limited to, the following steps, which are described with respect to the components of the processing system 200. In other embodiments, one or more steps of the method 300 may be replaced by a step of a different process for generating variant calls, e.g., using Variant Call Format (VCF), such as HaplotypeCaller, VarScan, Strelka, or SomaticSniper.

At step 300, optionally, the sequence processor 205 collapses aligned sequence reads of the input sequencing data. In one embodiment, collapsing sequence reads includes using UMIs, and optionally alignment position information from sequencing data of an output file (e.g., from the method 100 shown in FIG. 1) to identify and collapse multiple sequence reads (i.e., derived from the same original nucleic acid molecule) into a consensus sequence. In accordance with this step, a consensus sequence is determined from multiple sequence reads derived from the same original nucleic acid molecule that represents the most likely nucleic acid sequence, or portion thereof, of the original molecule. Since the UMI sequences are replicated through PCR amplification of the sequencing library, the sequence processor 205 can determine that certain sequence reads originated from the same molecule in a nucleic acid sample. In some embodiments, sequence reads that have the same or similar alignment position information (e.g., beginning and end positions within a threshold offset) and include a common UMI are collapsed, and the sequence processor 205 generates a collapsed read (also referred to herein as a consensus read) to represent the nucleic acid fragment. In some embodiments, the sequence processor 205 designates a consensus read as “duplex” if the corresponding pair of sequence reads (i.e., R₁ and R₂), or collapsed sequence reads, have a common UMI, which indicates that both positive and negative strands of the originating nucleic acid molecule have been captured; otherwise, the collapsed read is designated “non-duplex.” In some embodiments, the sequence processor 205 may perform other types of error correction on sequence reads as an alternative to, or in addition to, collapsing sequence reads.

At step 305, optionally, the sequence processor 205 may stitch sequence reads, or collapsed sequence reads, based on the corresponding alignment position information merging together two sequence reads into a single read segment. In some embodiments, the sequence processor 205 compares alignment position information between a first sequence read and a second sequence read (or collapsed sequence reads) to determine whether nucleotide base pairs of the first and second reads partially overlap in the reference genome. In one use case, responsive to determining that an overlap (e.g., of a given number of nucleotide bases) between the first and second reads is greater than a threshold length (e.g., threshold number of nucleotide bases), the sequence processor 205 designates the first and second reads as “stitched”; otherwise, the collapsed reads are designated “unstitched.” In some embodiments, a first and second read are stitched if the overlap is greater than the threshold length and if the overlap is not a sliding overlap. For example, a sliding overlap may include a homopolymer run (e.g., a single repeating nucleotide base), a dinucleotide run (e.g., two-nucleotide repeating base sequence), or a trinucleotide run (e.g., three-nucleotide repeating base sequence), where the homopolymer run, dinucleotide run, or trinucleotide run has at least a threshold length of base pairs.

At step 310, the sequence processor 205 may optionally assemble two or more reads, or read segments, into a merged sequence read (or a path covering the targeted region). In some embodiments, the sequence processor 205 assembles reads to generate a directed graph, for example, a de Bruijn graph, for a target region (e.g., a gene). Unidirectional edges of the directed graph represent sequences of k nucleotide bases (also referred to herein as “k-mers”) in the target region, and the edges are connected by vertices (or nodes). The sequence processor 205 aligns collapsed reads to a directed graph such that any of the collapsed reads may be represented in order by a subset of the edges and corresponding vertices.

In some embodiments, the sequence processor 205 determines sets of parameters describing directed graphs and processes directed graphs. Additionally, the set of parameters may include a count of successfully aligned k-mers from collapsed reads to a k-mer represented by a node or edge in the directed graph. The sequence processor 205 stores, e.g., in the sequence database 210, directed graphs and corresponding sets of parameters, which may be retrieved to update graphs or generate new graphs. For instance, the sequence processor 205 may generate a compressed version of a directed graph (e.g., or modify an existing graph) based on the set of parameters. In one use case, in order to filter out data of a directed graph having lower levels of importance, the sequence processor 205 removes (e.g., “trims” or “prunes”) nodes or edges having a count less than a threshold value, and maintains nodes or edges having counts greater than or equal to the threshold value.

At step 315, the variant caller 240 generates candidate variants from the sequence reads, collapsed sequence reads, or merged sequence reads assembled by the sequence processor 205. In one embodiment, the variant caller 240 generates the candidate variants by comparing sequence reads, collapsed sequence reads, or merged sequence reads (which may have been compressed by pruning edges or nodes in step 310) to a reference sequence of a target region of a reference genome (e.g., human reference genome hg19). The variant caller 240 may align edges of the sequence reads collapsed sequence reads, or merged sequence reads to the reference sequence, and records the genomic positions of mismatched edges and mismatched nucleotide bases adjacent to the edges as the locations of candidate variants. Additionally, the variant caller 240 may generate candidate variants based on the sequencing depth of a target region. In particular, the variant caller 240 may be more confident in identifying variants in target regions that have greater sequencing depth, for example, because a greater number of sequence reads help to resolve (e.g., using redundancies) mismatches or other base pair variations between sequences.

In one embodiment, the variant caller 240 generates candidate variants using the model 225 to determine expected noise rates for sequence reads from a subject (e.g., from a healthy subject). The model 225 may be a Bayesian hierarchical model, though in some embodiments, the processing system 100 uses one or more different types of models. Moreover, a Bayesian hierarchical model may be one of many possible model architectures that may be used to generate candidate variants and which are related to each other in that they all model position-specific noise information in order to improve the sensitivity or specificity of variant calling. More specifically, the machine learning engine 220 trains the model 225 using samples from healthy individuals to model the expected noise rates per position of sequence reads.

Further, multiple different models may be stored in the model database 215 or retrieved for application post-training. For example, a first model is trained to model SNV noise rates and a second model is trained to model indel noise rates. Further, the score engine 235 may use parameters of the model 225 to determine a likelihood of one or more true positives in a sequence read. The score engine 235 may determine a quality score (e.g., on a logarithmic scale) based on the likelihood. For example, the quality score is a Phred quality score Q=−10·log₁₀ P, where P is the likelihood of an incorrect candidate variant call (e.g., a false positive).

At step 320, the score engine 235 scores the candidate variants based on the model 225 or corresponding likelihoods of true positives or quality scores. Training and application of the model 225 is described in more detail below.

At step 325, the processing system 200 outputs the candidate variants. In some embodiments, the processing system 200 outputs some or all of the determined candidate variants along with the corresponding scores. Downstream systems, e.g., external to the processing system 200 or other components of the processing system 200, may use the candidate variants and scores for various applications including, but not limited to, predicting presence of cancer, disease, or germline mutations.

FIGS. 1-3 exemplify possible embodiments for generating sequencing read data and identifying candidate variants or rare mutation calls. However, as one of skill in the art would readily appreciate, other known means in the art for obtaining sequencing data, such as sequence reads or consensus sequence reads, and identifying candidate variants or rare mutation calls therefrom, can be used in the practice of the present invention (see, e.g., U.S. Patent Publication No. 2012/0065081, U.S. Patent Publication No. 2014/0227705, U.S. Patent Publication No. 2015/0044687 and U.S. Patent Publication No. 2017/0058332).

### IV. Example Models

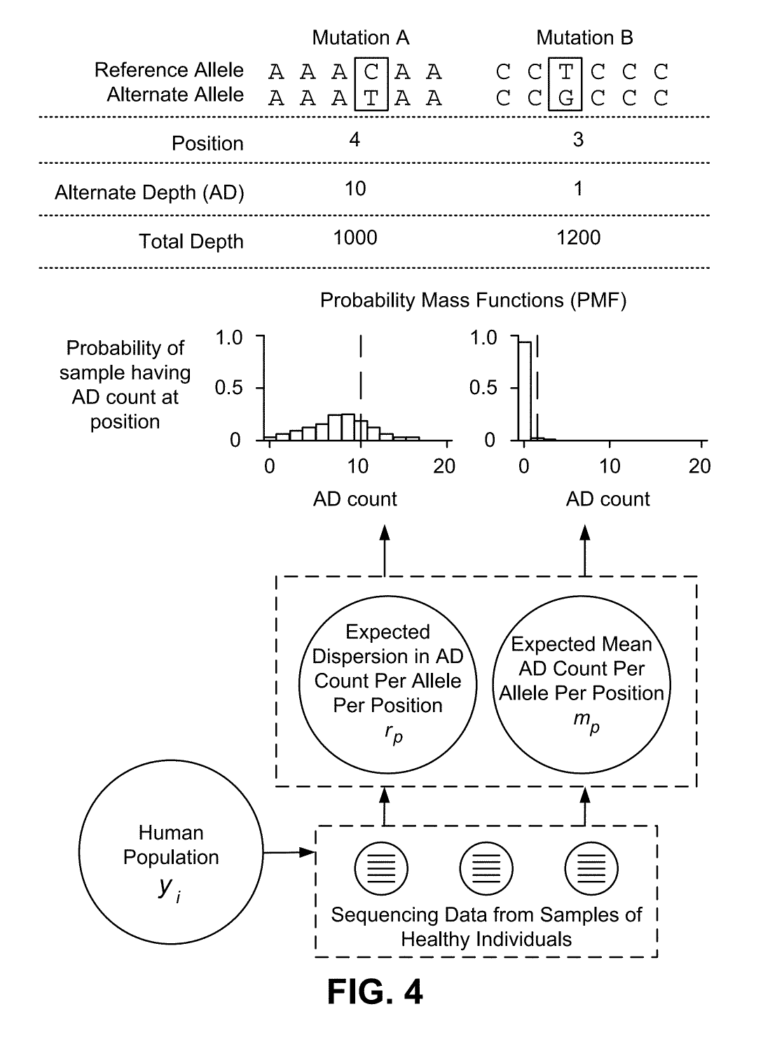

FIG. 4 is a diagram of an application of a Bayesian hierarchical model 225 according to one embodiment. Mutation A and Mutation B are shown as examples for purposes of explanation. In the embodiment of FIG. 4, Mutations A and B are represented as SNVs, though in other embodiments, the following description is also applicable to indels or other types of mutations. Mutation A is a C>T mutation at position 4 of a first reference allele from a first sample. The first sample has a first AD of 10 and a first total depth of 1000. Mutation B is a T>G mutation at position 3 of a second reference allele from a second sample. The second sample has a second AD of 1 and a second total depth of 1200. Based merely on AD (or AF), Mutation A may appear to be a true positive, while Mutation B may appear to be a false positive because the AD (or AF) of the former is greater than that of the latter. However, Mutations A and B may have different relative levels of noise rates per allele and/or per position of the allele. In fact, Mutation A may be a false positive and Mutation B may be a true positive, once the relative noise levels of these different positions are accounted for. The models 225 described herein model this noise for appropriate identification of true positives accordingly.

The probability mass functions (PMFs) illustrated in FIG. 4 indicate the probability (or likelihood) of a sample from a subject having a given AD count at a position. Using sequencing data from samples of healthy individuals (e.g., stored in the sequence database 210), the processing system 100 trains a model 225 from which the PMFs for healthy samples may be derived. In particular, the PMFs are based on mₚ, which models the expected mean AD count per allele per position in normal tissue (e.g., of a healthy individual), and rₚ, which models the expected variation (e.g., dispersion) in this AD count. Stated differently, mₚ and/or rₚ represent a baseline level of noise, on a per position per allele basis, in the sequencing data for normal tissue.

Using the example of FIG. 4 to further illustrate, samples from the healthy individuals represent a subset of the human population modeled by yᵢ, where i is the index of the healthy individual in the training set. Assuming for sake of example the model 225 has already been trained, PMFs produced by the model 225 visually illustrate the likelihood of the measured ADs for each mutation, and therefore provide an indication of which are true positives and which are false positives. The example PMF on the left of FIG. 4 associated with Mutation A indicates that the probability of the first sample having an AD count of 10 for the mutation at position 4 is approximately 20%. Additionally, the example PMF on the right associated with Mutation B indicates that the probability of the second sample having an AD count of 1 for the mutation at position 3 is approximately 1% (note: the PMFs of FIG. 4 are not exactly to scale). Thus, the noise rates corresponding to these probabilities of the PMFs indicate that Mutation A is more likely to occur than Mutation B, despite Mutation B having a lower AD and AF. Thus, in this example, Mutation B may be the true positive and Mutation A may be the false positive. Accordingly, the processing system 100 may perform improved variant calling by using the model 225 to distinguish true positives from false positives at a more accurate rate, and further provide numerical confidence as to these likelihoods.

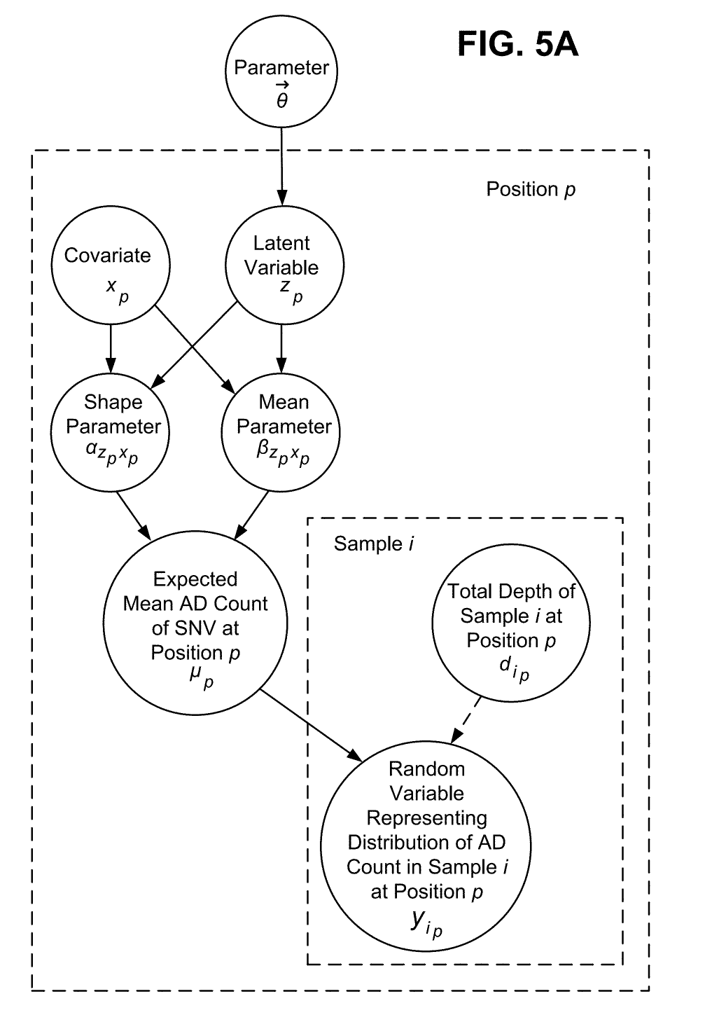

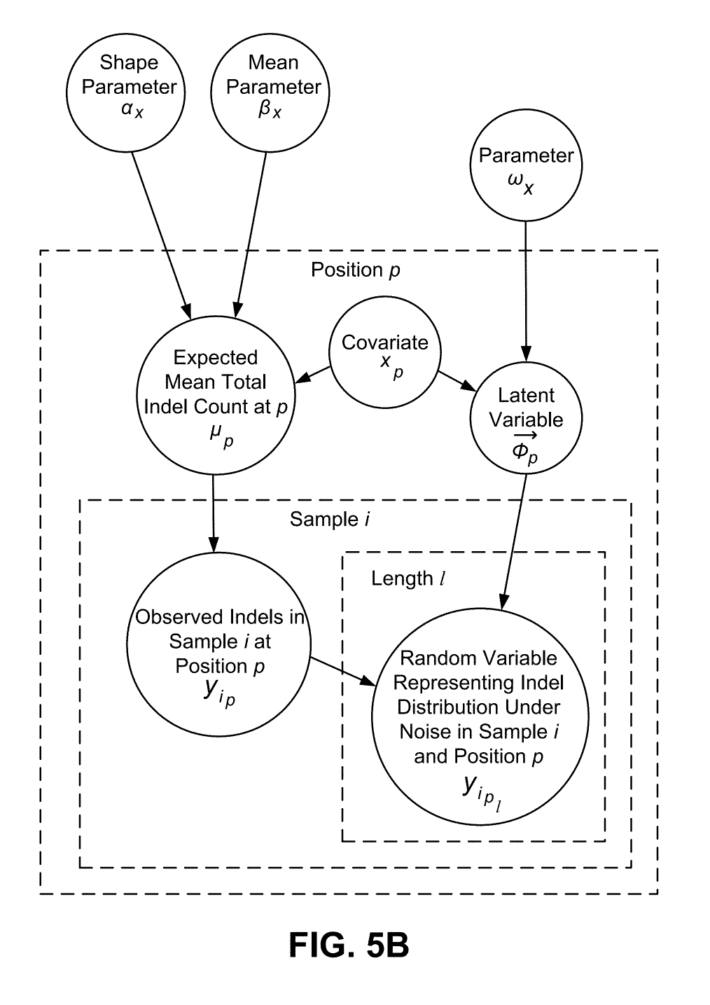

FIG. 5A shows dependencies between parameters and sub-models of a Bayesian hierarchical model 225 for determining true single nucleotide variants according to one embodiment. Parameters of models may be stored in the parameter database 230. In the example shown in FIG. 5A, \vec{θ} represents the vector of weights assigned to each mixture component. The vector \vec{θ} takes on values within the simplex in K dimensions and may be learned or updated via posterior sampling during training. It may be given a uniform prior on said simplex for such training. The mixture component to which a position p belongs may be modeled by latent variable zₚ using one or more different multinomial distributions:

zₚ˜Multinom(\vec{θ})

Together, the latent variable zₚ, the vector of mixture components \vec{θ}, α, and β allow the model for μ, that is, a sub-model of the Bayesian hierarchical model 225, to have parameters that “pool” knowledge about noise, that is they represent similarity in noise characteristics across multiple positions. Thus, positions of sequence reads may be pooled or grouped into latent classes by the model. Also advantageously, samples of any of these “pooled” positions can help train these shared parameters. A benefit of this is that the processing system 100 may determine a model of noise in healthy samples even if there is little to no direct evidence of alternate alleles having been observed for a given position previously (e.g., in the healthy tissue samples used to train the model).

The covariate xₚ (e.g., a predictor) encodes known contextual information regarding position p which may include, but is not limited to, information such as trinucleotide context, segmental duplication, distance closest to repeat, mappability, uniqueness, k-mer uniqueness, warnings for badly behaved regions of a sequence, or other information associated with sequence reads. Trinucleotide context may be based on a reference allele and may be assigned numerical (e.g., integer) representation. For instance, “AAA” is assigned 1, “ACA” is assigned 2, “AGA” is assigned 3, etc. Mappability represents a level of uniqueness of alignment of a read to a particular target region of a genome. For example, mappability is calculated as the inverse of the number of position(s) where the sequence read will uniquely map. Segmental duplications correspond to long nucleic acid sequences (e.g., having a length greater than approximately 1000 base pairs) that are nearly identical (e.g., greater than 90% match) and occur in multiple locations in a genome as result of natural duplication events (e.g., not associated with a cancer or disease).

The expected mean AD count of a SNV at position p is modeled by the parameter μₚ. For sake of clarity in this description, the terms μₚ and yₚ refer to the position specific sub-models of the Bayesian hierarchical model 225. In one embodiment, μₚ is modeled as a Gamma-distributed random variable having shape parameter α_{z}_{ₚ}_{,x}_{ₚ} and mean parameter β_{z}_{ₚ}_{,x}_{ₚ}:

μₚ˜Gamma(α_{z}_{ₚ}_{,x}_{ₚ},β_{z}_{ₚ}_{,x}_{ₚ})

In other embodiments, other functions may be used to represent μₚ, examples of which include but are not limited to: a log-normal distribution with log-mean γ_{z}_{ₚ} and log-standard-deviation σ_{z}_{ₚ}_{,x}_{ₚ}, a Weibull distribution, a power law, an exponentially-modulated power law, or a mixture of the preceding.

In the example shown in FIG. 5A, the shape and mean parameters are each dependent on the covariate xₚ and the latent variable zₚ, though in other embodiments, the dependencies may be different based on various degrees of information pooling during training. For instance, the model may alternately be structured so that α_{z}_{ₚ} depends on the latent variable but not the covariate. The distribution of AD count of the SNV at position p in a human population sample i (of a healthy individual) is modeled by the random variable yᵢ_{ₚ}. In one embodiment, the distribution is a Poisson distribution given a depth dᵢ_{ₚ} of the sample at the position:

yᵢ_{ₚ}|dᵢ_{ₚ}˜Poisson(dᵢ_{ₚ}·μₚ)

In other embodiments, other functions may be used to represent yᵢ_{ₚ}, examples of which include but are not limited to: negative binomial, Conway-Maxwell-Poisson distribution, zeta distribution, and zero-inflated Poisson.

FIG. 5B shows dependencies between parameters and sub-models of a Bayesian hierarchical model for determining true insertions or deletions according to one embodiment. In contrast to the SNV model shown in FIG. 5A, the model for indels shown in FIG. 5B includes different levels of hierarchy. The covariate xₚ encodes known features at position p and may include, e.g., a distance to a homopolymer, distance to a RepeatMasker repeat, or other information associated with previously observed sequence reads. Latent variable \vec{ϕₚ} may be modeled by a Dirichlet distribution based on parameters of vector \vec{ω}ₓ, which represent indel length distributions at a position and may be based on the covariate. In some embodiments, \vec{ω}ₓ is also shared across positions (\vec{ω}_{x,p}) that share the same covariate value(s). Thus for example, the latent variable may represent information such as that homopolymer indels occur at positions 1, 2, 3, etc. base pairs from the anchor position, while trinucleotide indels occur at positions 3, 6, 9, etc. from the anchor position.

The expected mean total indel count at position p is modeled by the distribution μₚ. In some embodiments, the distribution is based on the covariate and has a Gamma distribution having shape parameter αₓ_{ₚ} and mean parameter βₓ_{ₚ}_{z}_{ₚ}:

μₚ˜Gamma(αₓ_{ₚ},βₓ_{ₚ}_{z}_{ₚ})

In other embodiments, other functions may be used to represent μₚ, examples of which include but are not limited to: negative binomial, Conway-Maxwell-Poisson distribution, zeta distribution, and zero-inflated Poisson.

The observed indels at position p in a human population sample i (of a healthy individual) is modeled by the distribution yᵢ_{ₚ}. Similar to example in FIG. 5A, in some embodiments, the distribution of indel intensity is a Poisson distribution given a depth dᵢ_{ₚ} of the sample at the position:

yᵢ_{ₚ}|dᵢ_{ₚ}˜Poisson(dᵢ_{ₚ}·μₚ)

In other embodiments, other functions may be used to represent yᵢ_{ₚ}, examples of which include but are not limited to: negative binomial, Conway-Maxwell-Poisson distribution, zeta distribution, and zero-inflated Poisson.

Due to the fact that indels may be of varying lengths, an additional length parameter is present in the indel model that is not present in the model for SNVs. As a consequence, the example model shown in FIG. 5B has an additional hierarchical level (e.g., another sub-model), which is again not present in the SNV models discussed above. The observed count of indels of length l (e.g., up to 100 or more base pairs of insertion or deletion) at position p in sample i is modeled by the random variable yᵢ_{ₚᵢ}, which represents the indel distribution under noise conditional on parameters. The distribution may be a multinomial given indel intensity yᵢ_{ₚ} of the sample and the distribution of indel lengths \vec{ϕ}ₚ at the position:

\vec{y}ᵢ_{ₚᵢ}|yᵢ_{ₚ},\vec{ϕ}ₚ˜Multinom(yᵢ_{ₚ},\vec{ϕₚ})

In other embodiments, a Dirichlet-Multinomial function or other types of models may be used to represent yᵢ_{ₚᵢ}.

By architecting the model in this manner, the machine learning engine 220 may decouple learning of indel intensity (i.e., noise rate) from learning of indel length distribution. Independently determining inferences for an expectation for whether an indel will occur in healthy samples and expectation for the length of the indel at a position may improve the sensitivity of the model. For example, the length distribution may be more stable relative to the indel intensity at a number of positions or regions in the genome, or vice versa.

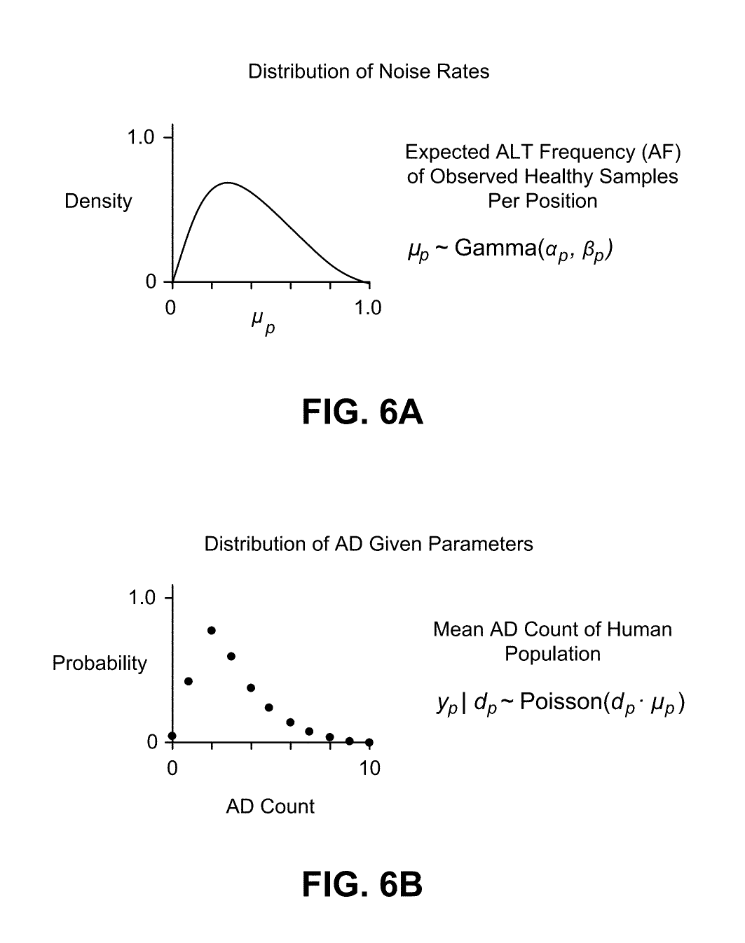

FIGS. 6A-B illustrate diagrams associated with a Bayesian hierarchical model 225 according to one embodiment. The graph shown in FIG. 6A depicts the distribution μₚ of noise rates, i.e., likelihood (or intensity) of SNVs or indels for a given position as characterized by a model. The continuous distribution represents the expected AF μₚ of non-cancer or non-disease mutations (e.g., mutations naturally occurring in healthy tissue) based on training data of observed healthy samples from healthy individuals (e.g., retrieved from the sequence database 210). Though not shown in FIG. 6A, in some embodiments, the shape and mean parameters of μₚ may be based on other variables such as the covariate xₚ or latent variable zₚ. The graph shown in FIG. 6B depicts the distribution of AD at a given position for a sample of a subject, given parameters of the sample such as sequencing depth dₚ at the given position. The discrete probabilities for a draw of μₚ are determined based on the predicted true mean AD count of the human population based on the expected mean distribution μₚ.

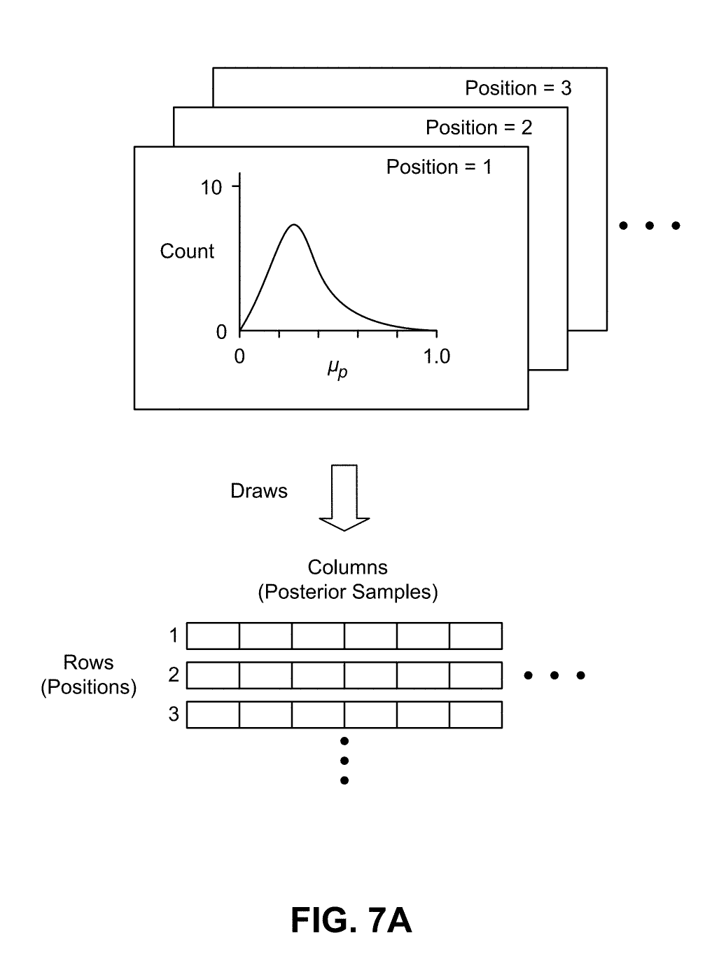

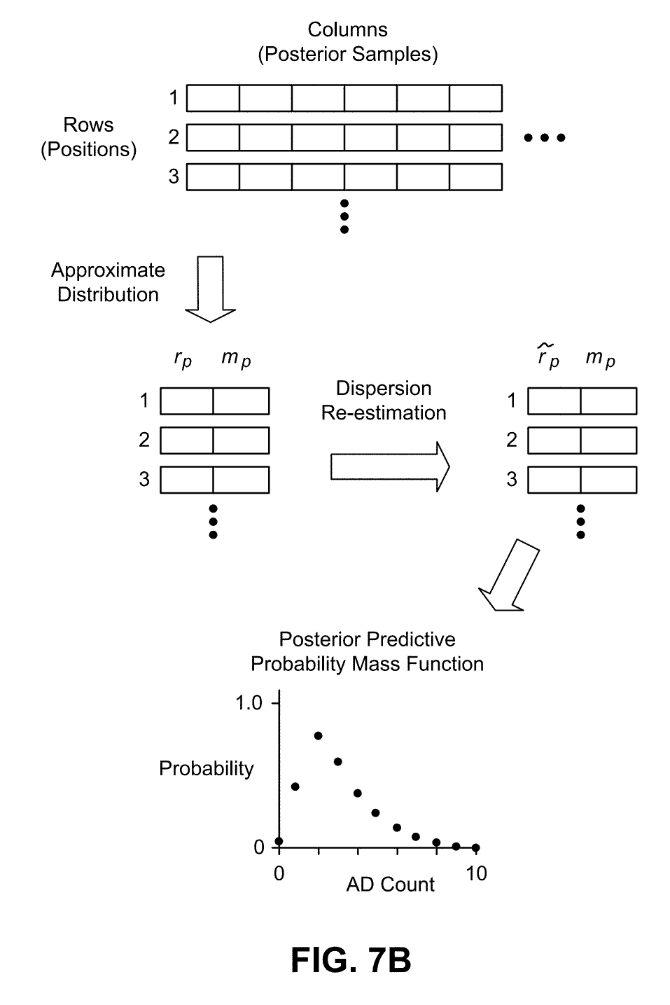

FIG. 7A is a diagram of an example process for determining parameters by fitting a Bayesian hierarchical model 225 according to one embodiment. To train a model, the machine learning engine 220 samples iteratively from a posterior distribution of expected noise rates (e.g., the graph shown in FIG. 6B) for each position of a set of positions. The machine learning engine 220 may use Markov chain Monte Carlo (MCMC) methods for sampling, e.g., a Metropolis-Hastings (MH) algorithm, custom MH algorithms, Gibbs sampling algorithm, Hamiltonian mechanics-based sampling, random sampling, among other sampling algorithms. During Bayesian Inference training, parameters are drawn from the joint posterior distribution to iteratively update all (or some) parameters and latent variables of the model (e.g., \vec{θ}, zₚ, α_{z}_{ₚ}_{,x}_{ₚ}, β_{z}_{ₚ}_{,x}_{ₚ}, μₚ, etc.).

In one embodiment, the machine learning engine 220 performs model fitting by storing draws of μₚ, the expected mean counts of AF per position and per sample, in the parameters database 230. The model is trained or fitted through posterior sampling, as previously described. In an embodiment, the draws of μₚ are stored in a matrix data structure having a row per position of the set of positions sampled and a column per draw from the joint posterior (e.g., of all parameters conditional on the observed data). The number of rows R may be greater than 6 million and the number of columns for N iterations of samples may be in the thousands. In other embodiments, the row and column designations are different than the embodiment shown in FIG. 7A, e.g., each row represents a draw from a posterior sample, and each column represents a sampled position (e.g., transpose of the matrix example shown in FIG. 7A).

FIG. 7B is a diagram of using parameters from a Bayesian hierarchical model 225 to determine a likelihood of a false positive according to one embodiment. The machine learning engine 220 may reduce the R rows-by-N column matrix shown in FIG. 7A into an R rows-by-2 column matrix illustrated in FIG. 7B. In one embodiment, the machine learning engine 220 determines a dispersion parameter rₚ (e.g., shape parameter) and mean parameter mₚ (which may also be referred to as a mean rate parameter mₚ) per position across the posterior samples μₚ. The dispersion parameter rₚ may be determined as

$${r}_{p} = \frac{{m}_{p}^{2}}{{v}_{p}^{2}} ,$$

where mₚ and vₚ are the mean and variance of the sampled values of μₚ at the position p, respectively. Those of skill in the art will appreciate that other functions for determining rₚ may also be used such as a maximum likelihood estimate.

The machine learning engine 220 may also perform dispersion re-estimation of the dispersion parameters in the reduced matrix, given the mean parameters. In one embodiment, following Bayesian training and posterior approximation, the machine learning engine 220 performs dispersion re-estimation by retraining for the dispersion parameters [symbol] based on a negative binomial maximum likelihood estimator per position. The mean parameter may remain fixed during retraining. In one embodiment, the machine learning engine 220 determines the dispersion parameters r′ₚ at each position for the original AD counts of the training data (e.g., yᵢ_{ₚ} and dᵢ_{ₚ} based on healthy samples). The machine learning engine 220 determines [symbol] =max(rₚ, r′ₚ), and stores [symbol] in the reduced matrix. Those of skill in the art will appreciate that other functions for determining [symbol] may also be used, such as a method of moments estimator, posterior mean, or posterior mode.

During application of trained models, the processing system 100 may access the dispersion (e.g., shape) parameters [symbol] and mean parameters mₚ to determine a function parameterized by [symbol] and mₚ. The function may be used to determine a posterior predictive probability mass function (or probability density function) for a new sample of a subject. Based on the predicted probability of a certain AD count at a given position, the processing system 100 may account for site-specific noise rates per position of sequence reads when detecting true positives from samples. Referring back to the example use case described with respect to FIG. 4, the PMFs shown for Mutations A and B may be determined using the parameters from the reduced matrix of FIG. 7B. The posterior predictive probability mass functions may be used to determine the probability of samples for Mutations A or B having an AD count at certain position.

### V. Example Process Flows

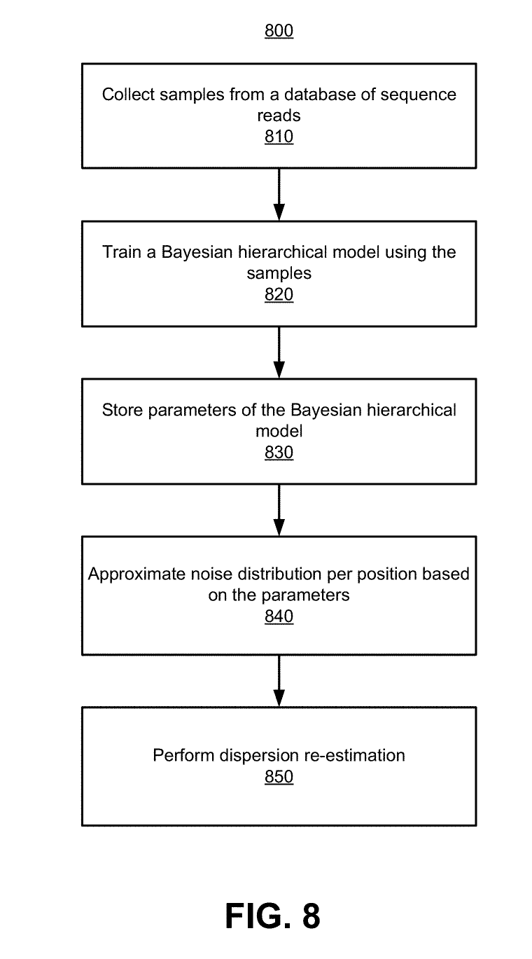

FIG. 8 is flowchart of a method 800 for training a Bayesian hierarchical model 225 according to one embodiment. In step 810, the machine learning engine 220 collects samples, e.g., training data, from a database of sequence reads (e.g., the sequence database 210). In step 820, the machine learning engine 220 trains the Bayesian hierarchical model 225 using the samples using a Markov Chain Monte Carlo method. During training, the model 225 may keep or reject sequence reads conditional on the training data. The machine learning engine 220 may exclude sequence reads of healthy individuals that have less than a threshold depth value or that have an AF greater than a threshold frequency in order to remove suspected germline mutations that are not indicative of target noise in sequence reads. In other embodiments, the machine learning engine 220 may determine which positions are likely to contain germline variants and selectively exclude such positions using thresholds like the above. In one embodiment, the machine learning engine 220 may identify such positions as having a small mean absolute deviation of AFs from germline frequencies (e.g., 0, ½, and 1).

The Bayesian hierarchical model 225 may update parameters simultaneously for multiple (or all) positions included in the model. Additionally, the model 225 may be trained to model expected noise for each ALT. For instance, a model for SNVs may perform a training process four or more times to update parameters (e.g., one-to-one substitutions) for mutations of each of the A, T, C, and G bases to each of the other three bases. In step 830, the machine learning engine 220 stores parameters of the Bayesian hierarchical model 225 (e.g., ensemble parameters output by the Markov Chain Monte Carlo method). In step 840, the machine learning engine 220 approximates noise distribution (e.g., represented by a dispersion parameter and a mean parameter) per position based on the parameters. In step 850, the machine learning engine 220 performs dispersion re-estimation (e.g., maximum likelihood estimation) using original AD counts from the samples (e.g., training data) used to train the Bayesian hierarchical model 225.

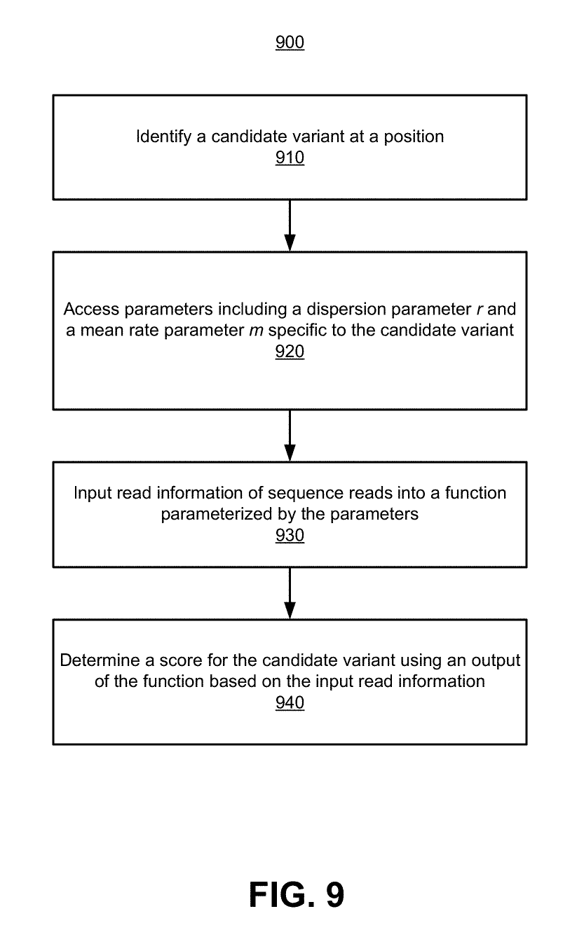

FIG. 9 is flowchart of a method 900 for determining a likelihood of a false positive according to one embodiment. At step 910, the processing system 100 identifies a candidate variant, e.g., at a position p of a sequence read, from a set of sequence reads, which may be sequenced from a cfDNA sample obtained from an individual. At step 920, the processing system 100 accesses parameters, e.g., dispersion and mean rate parameters [symbol] and mₚ, respectively, specific to the candidate variant, which may be based on the position p of the candidate variant. The parameters may be derived using a model, e.g., a Bayesian hierarchical model 225 representing a posterior predictive distribution with an observed depth of a given sequence read and a mean parameter μₚ at the position p as input. In an embodiment, the mean parameter μₚ is a gamma distribution encoding a noise level of nucleotide mutations with respect to the position p for a training sample.

At step 930, the processing system 100 inputs read information (e.g., AD or AF) of the set of sequence reads into a function (e.g., based on a negative binomial) parameterized by the parameters, e.g., [symbol] and mₚ. At step 940, the processing system 100 (e.g., the score engine 235) determines a score for the candidate variant (e.g., at the position p) using an output of the function based on the input read information. The score may indicate a likelihood of seeing an allele count for a given sample (e.g., from a subject) that is greater than or equal to a determined allele count of the candidate variant (e.g., determined by the model and output of the function). The processing system 100 may convert the likelihood into a Phred-scaled score. In some embodiments, the processing system 100 uses the likelihood to determine false positive mutations responsive to determining that the likelihood is less than a threshold value. In some embodiments, the processing system 100 uses the function to determine that a sample of sequence reads includes at least a threshold count of alleles corresponding to a gene found in sequence reads from a tumor biopsy of an individual. Responsive to this determination, the processing system 100 may predict presence of cancer cells in the individual based on variant calls. In some embodiments, the processing system 100 may perform weighting based on quality scores, use the candidate variants and quality scores for false discovery methods, annotate putative calls with quality scores, or provision to subsequent systems. The methods described above with respect to FIGS. 8 and 9 are, in various embodiments, performed on a computer, such as computing device 160 shown in FIG. 1.

### VI. Examples

The example results shown in the following figures were determined by the processing system 100 using one or more trained Bayesian hierarchical models 225. Bayesian hierarchical (BH) models 225 for SNVs and Indels may be referred to as a “SNV BH model” and “Indel BH model,” respectively. For purposes of comparison, some example results were determined without using a model 225 and are referred to as “no model” examples. In various embodiments, the results were generated using a targeted sequencing assay utilizing GRAIL's (GRAIL, Inc., Menlo Park, Calif.) proprietary 508 cancer gene panel to evaluate and call variants from targeted sequencing data from circulating cell-free DNA (cfDNA) samples obtained from subjects in one of two studies, Study “A” and Study “B,” as indicated in the figures. Study A included sequencing data from plasma samples obtained from 50 healthy subjects (no diagnosis of cancer) and 50 samples each from subjects with pre-metastatic breast cancer and pre-metastatic non-small cell lung cancer. Study B included evaluable sequencing data from plasma samples obtained from 124 cancer patients (39 subjects with metastatic breast cancer (MBC), 41 subjects with non-small cell lung cancer (NSCLC), and 44 subjects with castration-resistant prostate cancer (CRCP).

Whole blood was drawn into STRECK Blood Collection Tubes (BCT®) from healthy individuals and cancer patients, separated into plasma and buffy coat, and stored at −80° C. Cell-free DNA (cfDNA) was extracted from the plasma using a modified QIAmp Circulating Nucleic Acid kit (Qiagen, Germantown, Md.) and quantified using the Fragment Analyzer High Sensitivity NGS kit (Advanced Analytical Technologies, Akneny Iowa). A sequencing library was prepared from extracted cfDNA with a modified Illumina TruSeq DNA Nano protocol (ILLUMINA®; San Diego, Calif.). The library preparation protocol included adapter ligation of sequencing adapters comprising unique molecular identifiers (UMIs) used for error correction as described above. Sequencing libraries were PCR amplified and quantified using the Fragment Analyzer Standard Sensitivity NGS kit.

Quantified DNA libraries underwent hybridization-based capture with GRAIL's proprietary research panel targeting 508 cancer related genes (GRAIL, Inc., Menlo Park, Calif.). Target DNA molecules were first captured using biotinlyated single-stranded DNA hybridization probes and then enriched using magnetic streptavidin beads. Non-target molecules were removed using subsequent wash steps. Enriched libraries were sequenced on a HiSex X using the HiSeq X Reagent Kit v2.5 (ILLUMINA®; San Diego, Calif.) at a nominal raw target coverage of 60,000×. Four libraries were pooled per flowcell and dual indexing primer mix was included to enable dual sample indexing reads. The read lengths were set to 150, 150, 8, and 8, respectively for read 1, read 2, index read 1, and index read 2. The first 6 base reads in read 1 and read 2 were the UMI sequences.

### VI. A. Example Mutation Rates

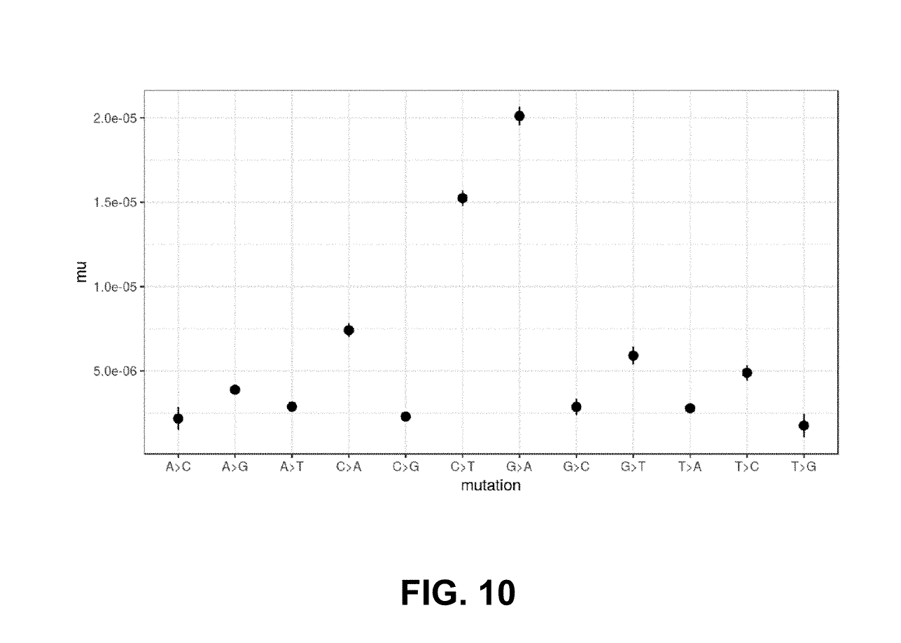

FIG. 10 is a diagram of mutation-specific noise rates according to one embodiment. The example results shown in FIG. 10 were obtained from healthy samples using targeted sequencing data from Study B. A trained SNV BH model may learn that certain types of SNVs have a greater baseline noise level in healthy samples. In the example diagram shown in FIG. 10, C>T and G>A substitution mutations are more likely than the other types of substitutions included in the diagram.

### VI. B. Example Mutation Rates Based on Trinucleotide Context

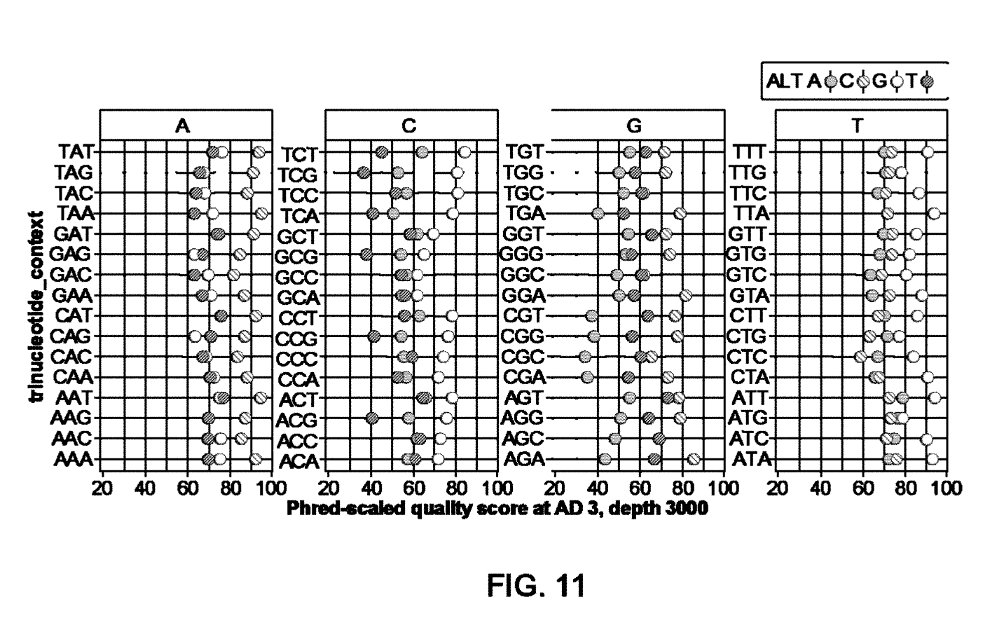

FIG. 11 is a diagram of noise rates based on reference allele and trinucleotide context according to one embodiment. The example results shown in FIG. 11 were obtained from healthy samples across a set of baseline individuals using targeted sequencing data from Study B. A trained SNV BH model may learn that the mean and variance of baseline noise levels for SNVs may vary based on trinucleotide context. The example results shown in FIG. 11 were obtained for healthy samples having an AD of 3 and depth of 3000. In addition, the noise levels (e.g., likelihood of given SNV based on trinucleotide context) are converted into Phred-scaled quality scores, where Q=−10·log₁₀P. For example, a Phred quality score of 20 indicates a P= 1/100 chance of an incorrect variant call, and a Phred quality score of 60 indicates a P= 1/1,000,000 chance of an incorrect variant call. Thus, greater Phred quality scores correspond to greater confidence for a detected mutation, e.g., to distinguish between a true positive and a false positive from noise in sequence reads.

### VI. C. Example Quality Scores

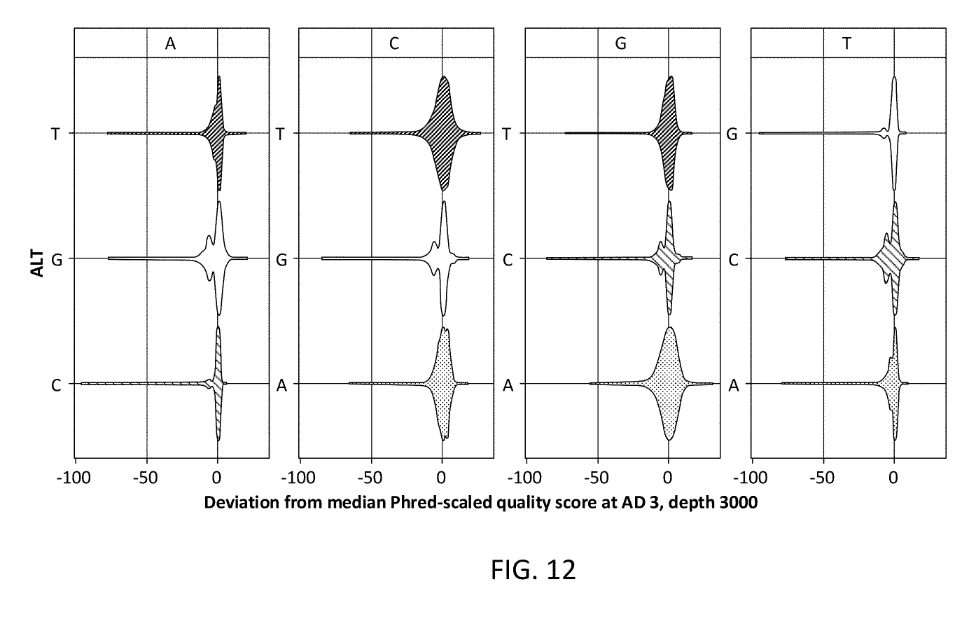

FIG. 12 is a diagram of distributions of quality score deviations by reference allele according to one embodiment. The example results shown in FIG. 12 were obtained using targeted sequencing data from Study B obtained from healthy samples having an AD of 3 and a depth of 3000. Moreover, the results show that a SNV BH model may identify distinct subsets of positions by noise behavior using the mixture components, which correspond to the various modes seen in the plots. The long tails may indicate that the model learns to suppress recurrent mutations (e.g., not true positives). The x-axis includes negative values because the graphed deviations represent differences between a Phred quality score at a position and the median Phred quality score for similar positions. The model learns that certain positions may have higher or lower median Phred quality scores relative to other positions.

### VI. D. Example Quality Scores

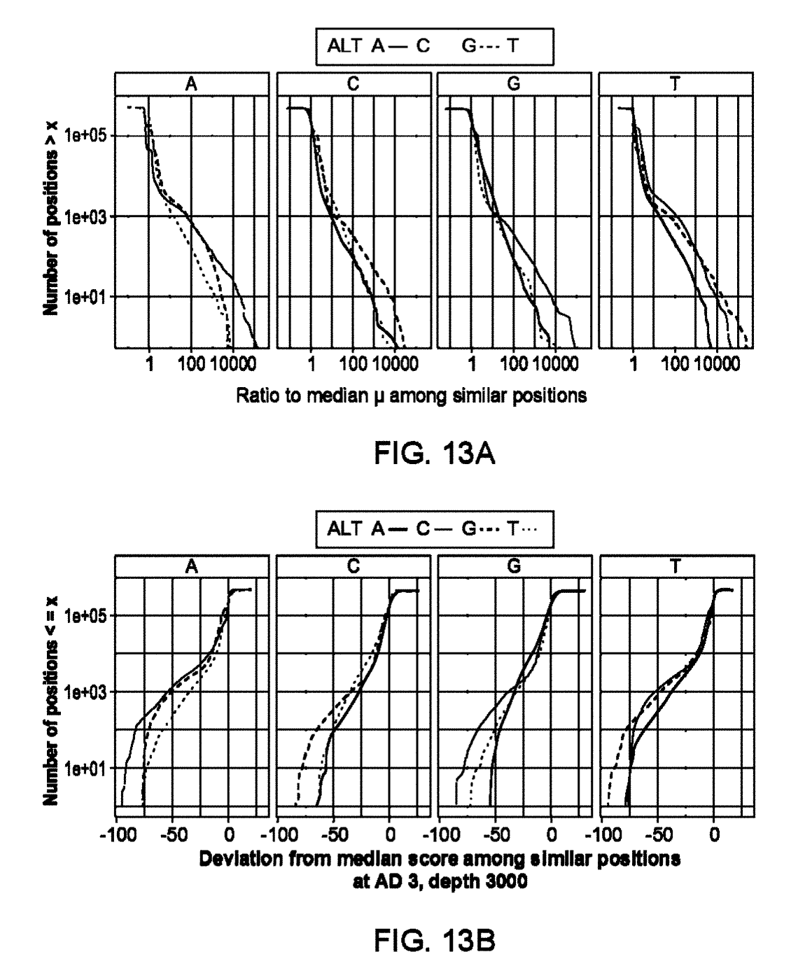

FIGS. 13A-B show diagrams illustrating deviations from median quality scores by reference allele according to one embodiment. The example results shown in FIGS. 13A-B were obtained from targeted sequencing data obtained from healthy samples from Study B. The example results of FIG. 13A indicate that a SNV BH model may learn that noise levels at most positions are typical in healthy samples. For instance, it may be common for positions to exhibit at least some low level of consistent noise, but a subset of positions exhibit extraordinarily high levels of noise. For instance, in each of the four plots corresponding to reference alleles A, C, G, and T, for only 1 position (on the x-axis), is μₚ greater than 10⁵ times (on the y-axis) the median noise level of similar positions. Additionally, for some of the mutation types, over 100 positions (on the x-axis) have μₚ greater than 100 times (on the y-axis) the median noise level of similar positions, which may contribute to detected false positives.

The example results of the FIG. 13B indicate that a SNV BH model determines low Phred quality scores for positions corresponding to pathological positions in healthy samples. Thus, the model may use the quality scores filter out artifacts from true positives that have greater quality scores on average. In addition, recurrent mutations may be removed by the model even when some covariates or predictors are not known.

### VI. E. Example Quality Scores

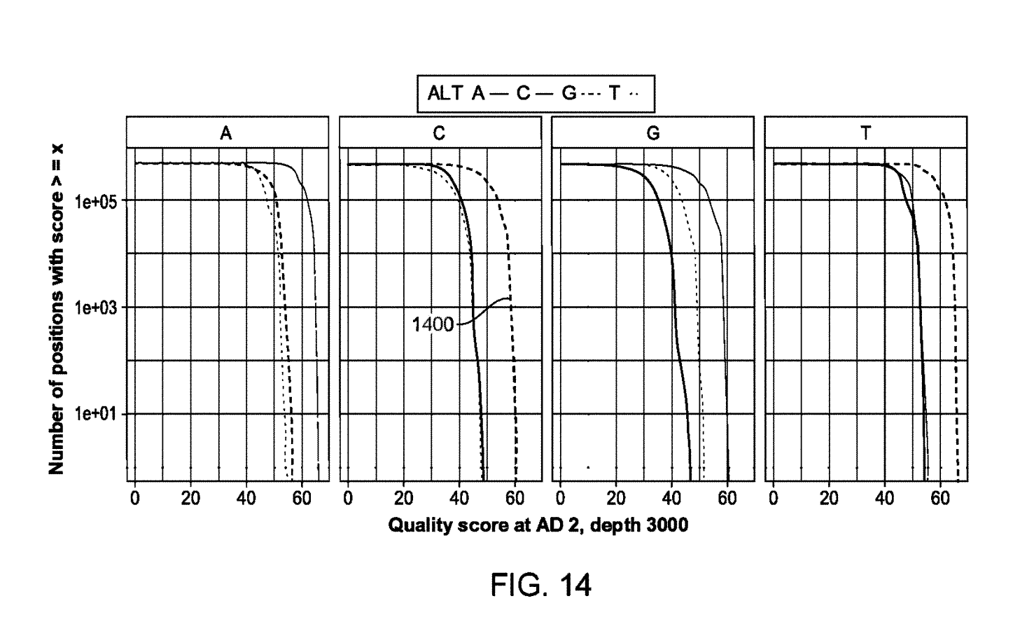

FIG. 14 is a diagram of quality scores by reference allele at a low alternate depth according to one embodiment. The example results shown in FIG. 14 were obtained using targeted sequencing data from Study B for a healthy sample having an AD of 2 and a depth of 3000. Further, the curve 1400 of the results show that some SNVs such as a C>G mutation has high Phred quality scores (e.g., certain parts of the genome receive a sensitivity boost), thus allowing a SNV BH model that includes position specific noise modeling to better call variants of that mutation type at certain positions.

### VI. F. Example Mean Calls

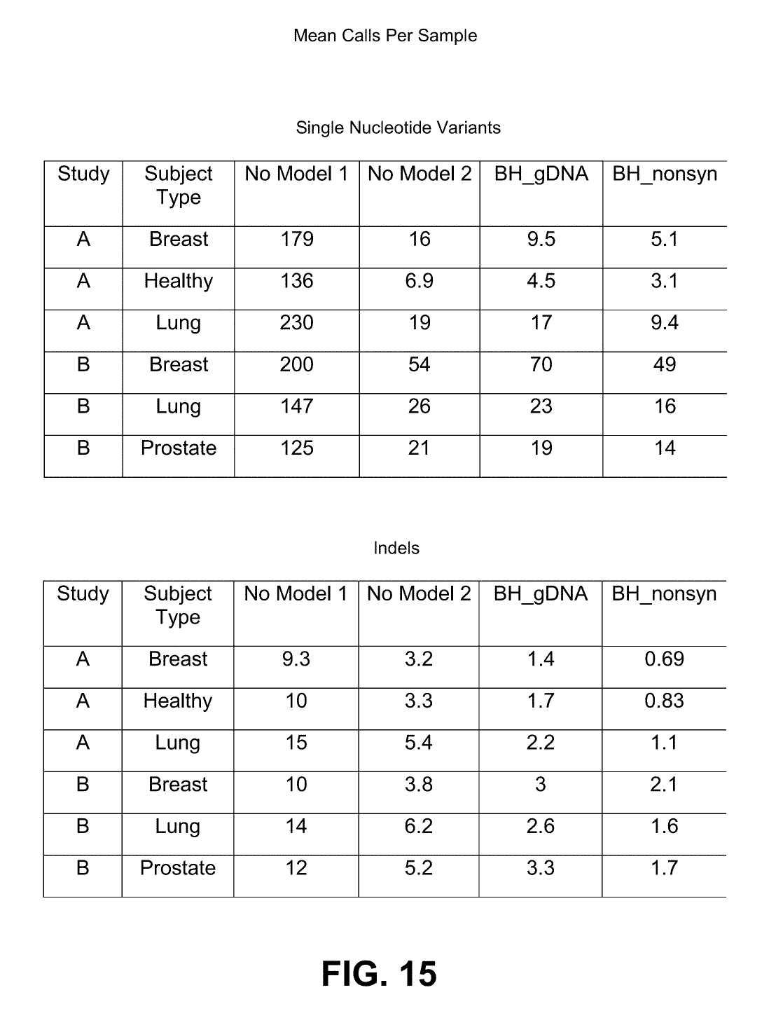

FIG. 15 is a diagram of mean calls per sample using a SNV BH model, Indel BH model, or no model across sample targeted sequencing assays according to one embodiment. The example results for both SNV and indel type mutations shown in FIG. 15 were obtained from targeted sequencing data from healthy subjects and cancer patients (having breast, lung, or prostate cancer). In addition, the example results were obtained using targeted sequencing data from Study A and Study B, as indicated. In some embodiments, a “No Model” method uses a manually tuned filter to set thresholds, e.g., to filter for variants having an AD greater than or equal to 3 and an AF greater than or equal to 0.1. The results determined using the BH models indicate improved sensitivity relative to the baseline results that did not use the model. For instance, in the breast cancer sample in Study A for a SNV model, the baseline number of mean calls per sample are 179 and 16 for “No Model 1” and “No Model 2,” respectively. However, the number of mean calls per sample are lower at 9.5 and 5.1 for “BH_gDNA” and “BH_nonsyn,” respectively. Thus, the model provides greater control over false positives.

### VI. G. Example Positive Percentage Agreement

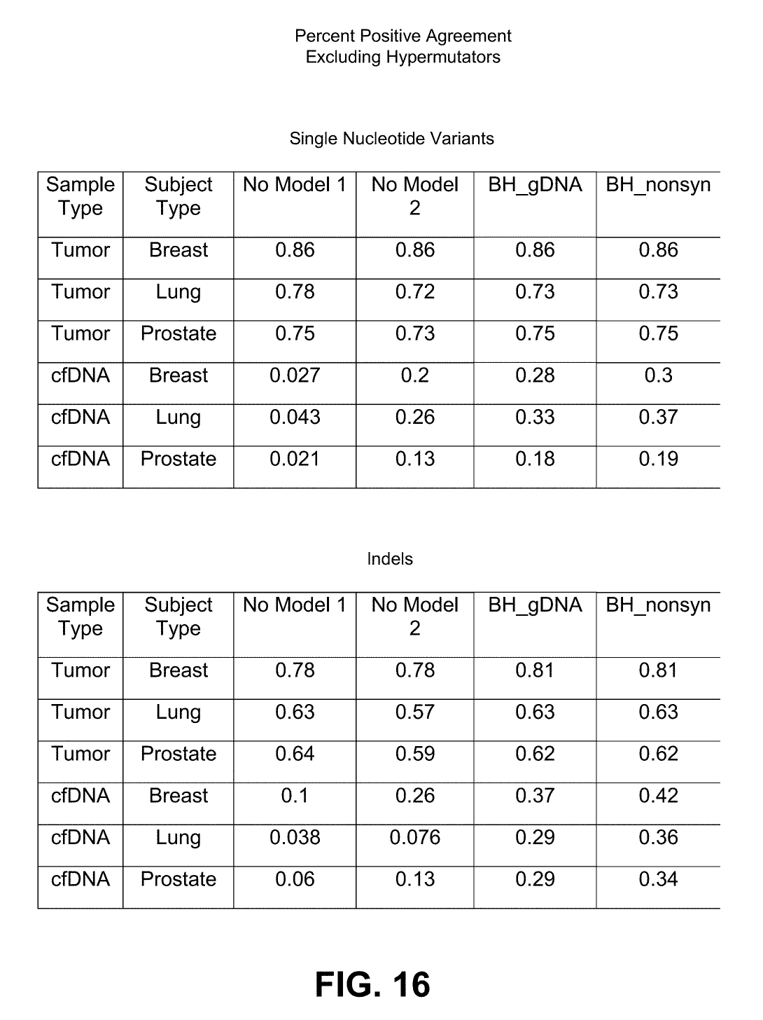

FIG. 16 is a diagram of positive percentage agreement (PPA) results for sequence data from cfDNA samples (“cfDNA”) and from matched tumor biopsy samples (“Tumor”) using a SNV BH model, Indel BH model, or no model according to one embodiment. Sequencing data from the matched tumor biopsy samples was obtained using MSK-IMPACT, a hybridization capture-based next-generation sequencing assay, which analyzes all protein-coding exons of 410 cancer-associated genes as previously described (Cheng, et al., J. Molecular Diagnostics, vol. 17, no. 3, pp. 251-264 (2015)).

The example results for both SNV and indel type mutations (excluding hypermutators) shown in FIG. 16 were obtained from cfDNA and matched tumor biopsy samples of subjects having breast, lung, or prostate cancer. The PPA values for cfDNA and matched tumor biopsy samples are calculated using the following equations, where “tumor” represents the number of variant calls from the tumor sample and “cfDNA” represents the number of variant calls from the corresponding cfDNA sample:

$${PPA}_{tumor} = \frac{tumor + cfDNA}{tumor}$$

$${PPA}_{cfDNA} = \frac{tumor + cfDNA}{cfDNA}$$

As shown by the example results, the BH models retain concordant mutations and in several cases improve sensitivity (e.g., greater PPA) of concordant mutations. For instance, in the breast cancer cfNDA sample for indels, the baseline PPA are 0.1 and 0.26 for “No Model 1” and “No Model 2,” respectively. However, the PPA increases to 0.37 and 0.42 for “BH_gDNA” and “BH_nonsyn,” respectively.

### VI. H. Example Positive Percentage Agreement

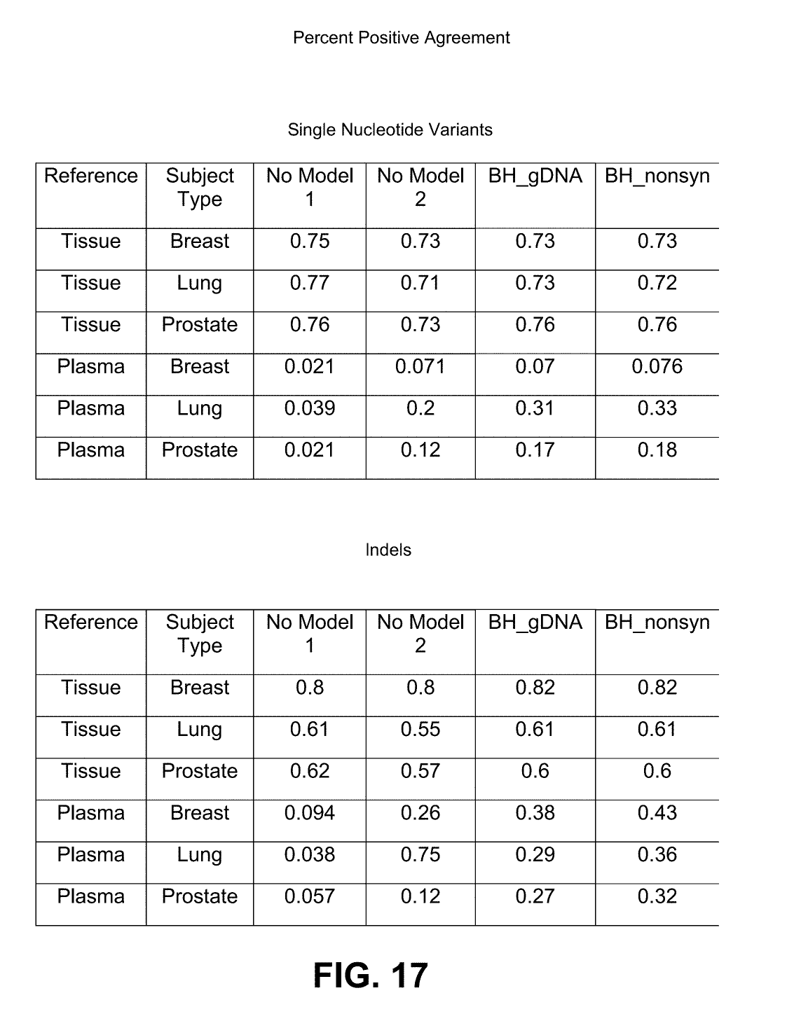

FIG. 17 is another diagram of positive percentage agreement results for sequence data using a SNV BH model, Indel BH model, or no model according to one embodiment. The example results for both SNV and indel type mutations shown in FIG. 17 were obtained from samples of subjects having breast, lung, or prostate cancer and using tumor (tissue) and cfDNA (plasma) as a reference. Similar to the PPA example results shown in FIG. 16, the example results of FIG. 17 also indicate that the BH models retain concordant mutations and in several cases improve sensitivity (e.g., greater PPA) of concordant mutations. The positive percentage agreement results shown in FIG. 17 include hypermutators, which may include additional variants not found in a single biopsy.

### VI. I. Example Genes Detected

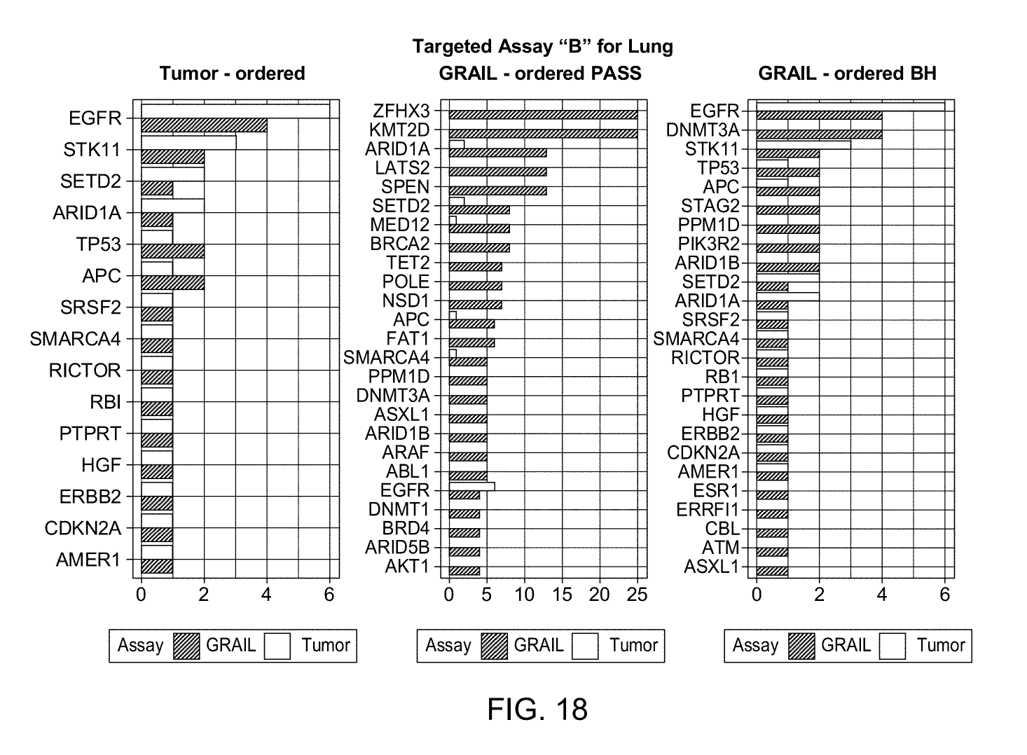

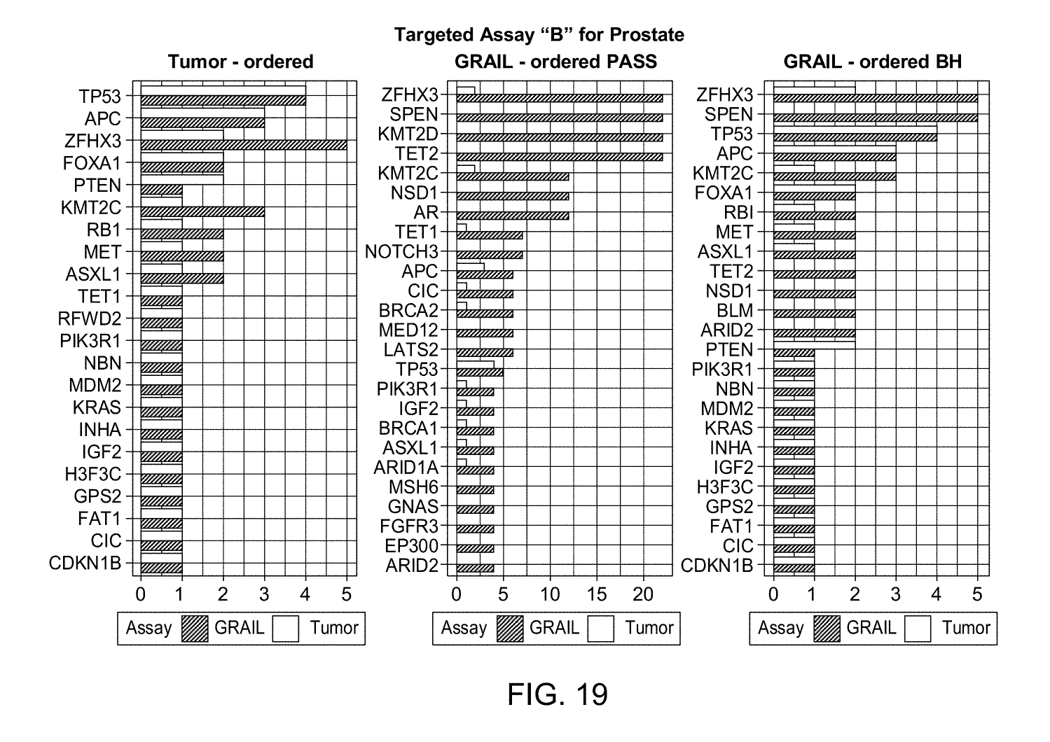

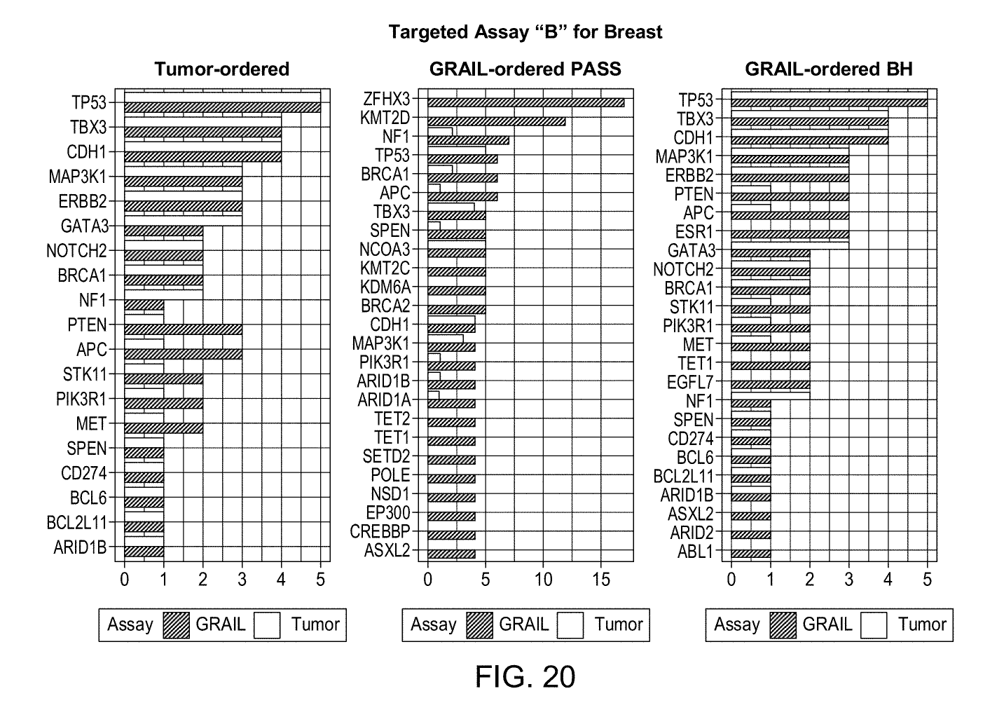

FIG. 18 is a diagram depicting the number of mutations detected in specific genes from targeted sequencing data from subjects with lung cancer according to one embodiment. FIG. 19 is a diagram depicting the number of mutations detected in specific genes detected from targeted sequencing data from subjects with prostate cancer according to one embodiment. FIG. 20 is a diagram depicting the number of mutations detected in specific genes from targeted sequencing data from subjects with breast cancer according to one embodiment. The example results shown in FIGS. 18-20 were obtained using targeted sequencing data from Study B and using samples of subjects having the respective type of cancer indicated. The example results shown in FIG. 18 were obtained using an SNV BH model, and the example results shown in FIGS. 19-20 were obtained using an SNV Indel model.

The “Tumor-ordered” results indicate that target cancer genes detected by the tumor-based “GRAIL” and cfDNA-based “Tumor” assays generally match. The baseline “GRAIL-ordered PASS” results obtained without using the BH models indicate that the “GRAIL” assay detects mutations in genes that do not match either of the target cancer genes or the genes detected by the “Tumor” assay. However, the “GRAIL-ordered BH” results obtained using the BH models indicate that the “GRAIL” assay detects genes that matches some of the target cancer genes and some of the genes detected by the “Tumor” assay. For instance, in FIG. 18, genes EGFR and STK11 both appear at the top of the “Tumor-ordered” and “GRAIL-ordered BH” results. In FIG. 19, genes TP53 and ZFHX3 both appear at the top of the “Tumor-ordered” and “GRAIL-ordered BH” results. In FIG. 20, genes TP53, TBX3, CDH1, MAP3K1, and ERBB2 each appear at the top of the “Tumor-ordered” and “GRAIL-ordered BH” results.

### VI. J. Example Mutations Filtered

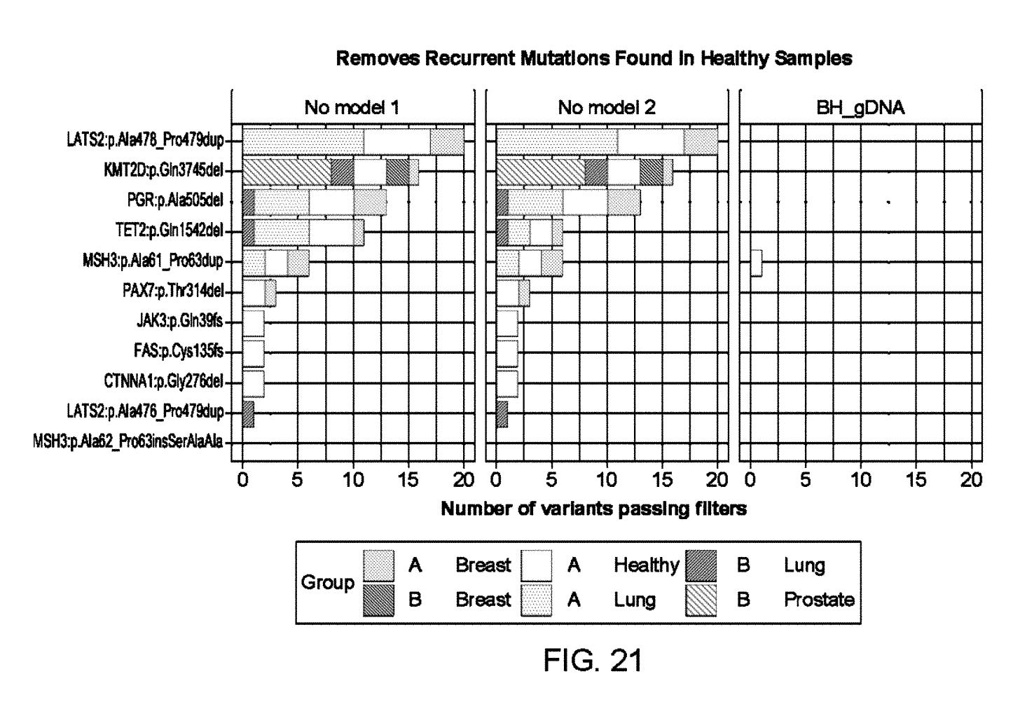

FIG. 21 is a diagram of filtered recurrent mutations from healthy samples using an Indel BH model according to one embodiment. The example results shown in FIG. 21 were obtained from samples of subjects having breast, lung, or prostate cancer and using target sequencing data from Studies A and B, as indicated. The results show that the “BH_gDNA” assay using the model filters out recurrent mutations found in healthy samples, while results of the baseline “No Model 1” and “No Model 2” assays retain many of those recurrent mutations.

### VI. K. Example Mutations Retained

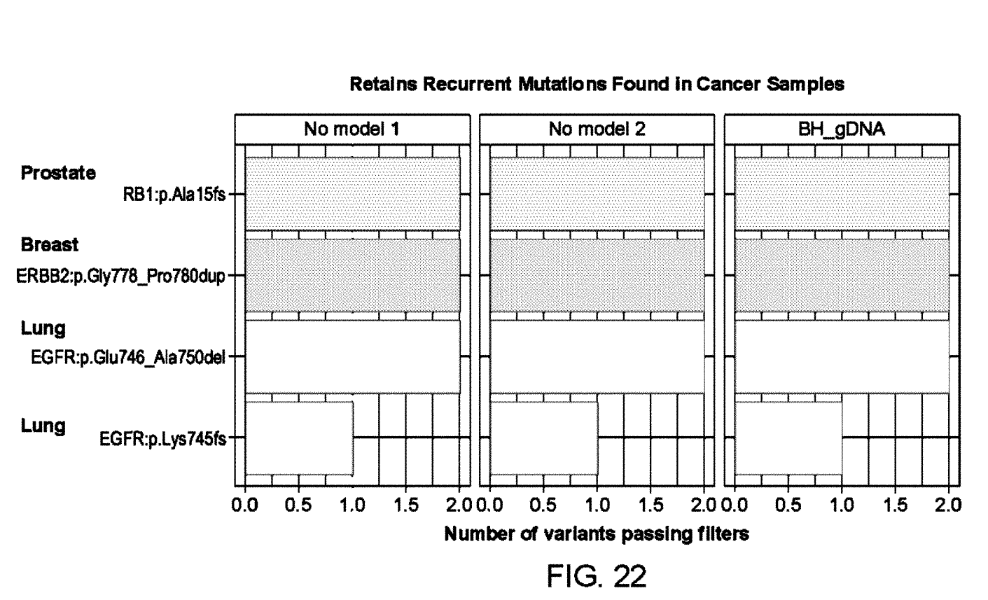

FIG. 22 is a diagram of filtered recurrent mutations from cancer samples using an Indel BH model according to one embodiment. The example results shown in FIG. 22 were obtained from samples of subjects having breast, lung, or prostate cancer and using target sequencing data from Study B. The results show that the “BH_gDNA” assay using the model retains recurrent mutations found in cancer samples, as do the baseline “No Model 1” and “No Model 2” assays.

### VI. L. Example Indel Noise

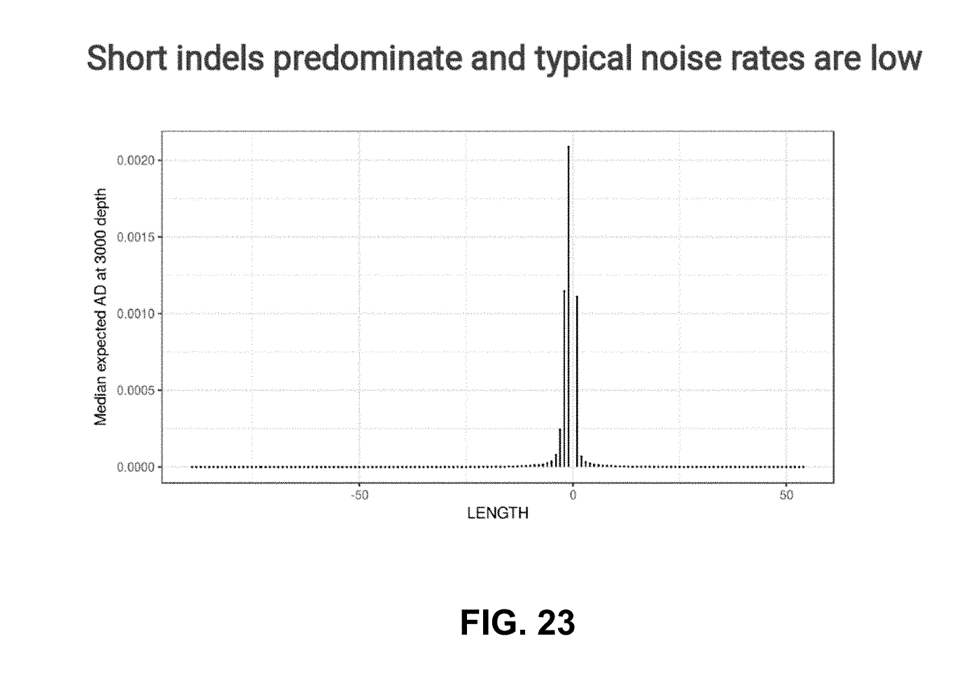

FIG. 23 is a diagram of noise rates for indels determined using an Indel BH model according to one embodiment. The example results shown in FIG. 23 were obtained using targeted sequencing data from Study B for a healthy sample having a depth of 3000. Further, the results show that short indels (e.g., of length −2, −1, or 1) dominate the mean expected AD, while typical noise rates for longer indels are low.

### VI. M. Example Indel Noise

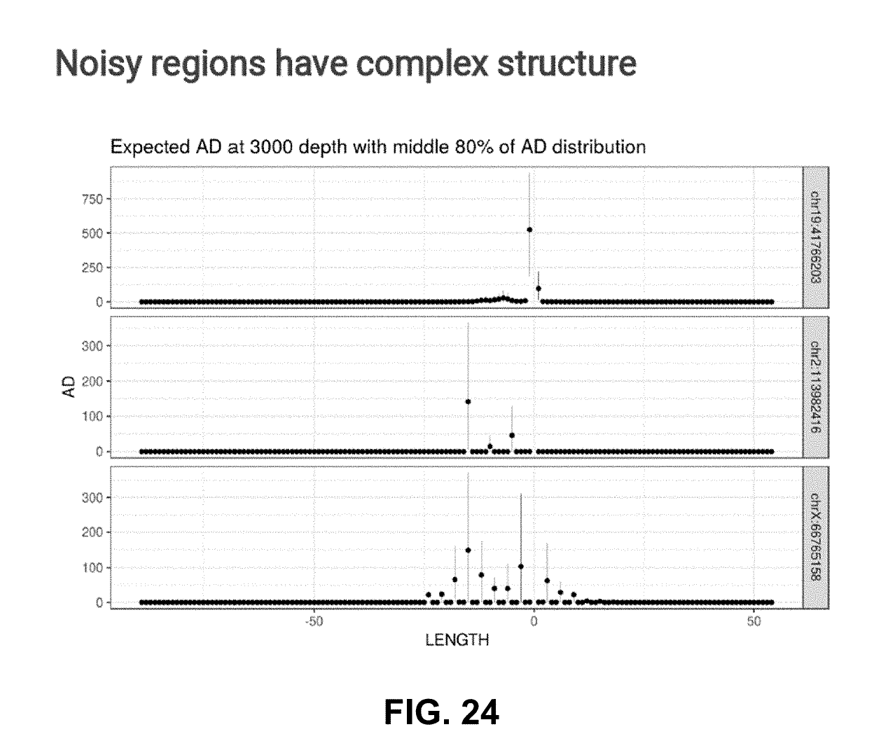

FIG. 24 is another diagram of noise rates for indels determined using an Indel BH model according to one embodiment. The example results shown in FIG. 24 were obtained using targeted sequencing data from Study B for homopolymer (top), pentanucleotide (middle), and trinucleotide (bottom) healthy samples having a depth of 3000. The results show that noisy regions may have a complex structure of expected AD distribution. For instance, indels of length −1 and 1 are noisy in the homopolymer sample relative to longer indels. Indels of length −5, −10, and −15 are noisy in the pentanucleotide sample relative to longer indels. Indels of length 9, 6, 3, −3, −6, −9, −12, −15, and −18, are noisy in the trinucleotide sample relative to longer indels.

### VII. Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for processing sequencing data of a nucleic acid sample, the method comprising:
identifying a candidate variant of a plurality of sequence reads;
accessing a plurality of parameters including a dispersion parameter r and a mean rate parameter m specific to the candidate variant, the r and m having been derived using a model;
inputting read information of the plurality of sequence reads into a function parameterized by the plurality of parameters; and
determining a score for the candidate variant using an output of the function based on the input read information.

2. The method of claim 1, wherein the plurality of parameters represent mean and shape parameters of a gamma distribution, and wherein the function is a negative binomial based on the plurality of sequence reads and the plurality of parameters.

3. The method of claim 2, wherein the plurality of parameters represent parameters of a distribution that encodes an uncertainty level of nucleotide mutations with respect to a given position of a sequence read.

4. The method of claim 3, wherein a gamma distribution is one component of a mixture of the distribution.

5. The method of claim 1, wherein the plurality of parameters are derived from a training sample of sequence reads from a plurality of healthy individuals.

6. The method of claim 5, wherein the training sample excludes a subset of the sequence reads from the plurality of healthy individuals based on filtering criteria.

7. The method of claim 6, wherein the filtering criteria indicates to exclude sequence reads that have (i) a depth less than a threshold value or (ii) an allele frequency greater than a threshold frequency.

8. The method of claim 6, wherein the filtering criteria varies based on positions of candidate variants in a genome.

9. The method of claim 1, wherein the plurality of parameters are derived using a Bayesian Hierarchical model.

10. The method of claim 9, wherein the Bayesian Hierarchical model includes a multinomial distribution grouping positions of sequence reads into latent classes.

11. The method of claim 9, wherein the Bayesian Hierarchical model includes fixed covariates unrelated to training samples from healthy individuals.

12. The method of claim 11, wherein the covariates are based on a plurality of nucleotides adjacent to a given position of a sequence read.

13. The method of claim 11, wherein the covariates are based on a level of uniqueness of a given sequence read relative to a target region of a genome.

14. The method of claim 11, wherein the covariates are based whether a given sequence read is a segmental duplication.

15. The method of claim 9, wherein the Bayesian Hierarchical model is estimated using a Markov chain Monte Carlo method.

16. The method of claim 15, wherein the Markov chain Monte Carlo method uses a Metropolis-Hastings algorithm.

17. The method of claim 15, wherein the Markov chain Monte Carlo method uses a Gibbs sampling algorithm.

18. The method of claim 15, wherein the Markov chain Monte Carlo method uses Hamiltonian mechanics.

19. The method of claim 1, wherein the read information includes a depth d of the plurality of sequence reads, the function parameterized by m·d.

20. The method of claim 1, wherein the score is a Phred-scaled likelihood.

21. The method of claim 1, wherein the plurality of sequence reads is sequenced from a cell free nucleotide sample obtained from an individual.

22. The method of claim 21, further comprising:
collecting or having collected the cell free nucleotide sample from a blood sample of the individual; and
performing enrichment on the cell free nucleotide sample to generate the plurality of sequence reads.

23. The method of claim 1, wherein the plurality of sequence reads is sequenced from a sample of blood, whole blood, plasma, serum, urine, cerebrospinal fluid, fecal, saliva, tears, a tissue biopsy, pleural fluid, pericardial fluid, or peritoneal fluid of an individual.

24. The method of claim 1, wherein the plurality of sequence reads is sequenced from a tumor biopsy.

25. The method of claim 1, wherein the plurality of sequence reads is sequenced from an isolate of cells from blood, the isolate of cells including at least buffy coat white blood cells or CD4+ cells.

26. The method of claim 1, further comprising:
determining that the candidate variant is a false positive mutation responsive to comparing the score to a threshold value.

27. The method of claim 1, wherein the candidate variant is a single nucleotide variant.

28. The method of claim 27, wherein the model encodes noise levels of nucleotide mutations for one base of A, T, C, and G to each of the other three bases.

29. The method of claim 1, wherein the candidate variant is an insertion or deletion of at least one nucleotide.

30. The method of claim 29, wherein the model includes a distribution of lengths of insertions or deletions.

31. The method of claim 29, wherein the model separates inference for determining a likelihood of an alternate allele from inference for determining a length of the alternate allele using the distribution of lengths.

32. The method of claim 29, wherein the distribution of lengths is multinomial with Dirichlet prior.

33. The method of claim 32, wherein the Dirichlet prior on the multinomial distribution of lengths is determined by covariates of anchor positions of a genome.

34. The method of claim 29, wherein the model includes a distribution ω determined based on covariates.

35. The method of claim 29, wherein the model includes a distribution ϕ determined based on covariates and anchor positions of a genome.

36. The method of claim 29, wherein the model includes a multinomial distribution grouping lengths of insertions or deletions at anchor positions of sequence reads into latent classes.

37. The method of claim 29, wherein an expected mean total count of insertions or deletions at a given anchor position is modeled by a distribution based on covariates and anchor positions of a genome.

38. A system comprising a computer processor and a memory, the memory storing computer program instructions that when executed by the computer processor cause the processor to perform steps comprising the steps of:
identifying a candidate variant of a plurality of sequence reads;
accessing a plurality of parameters including a dispersion parameter r and a mean rate parameter m specific to the candidate variant, the r and m having been derived using a model;
inputting read information of the plurality of sequence reads into a function parameterized by the plurality of parameters; and
determining a score for the candidate variant using an output of the function based on the input read information.
